(19) United States
(12) Patent Application Publication
(10) Pub. No.: US 2008/0212942 A1
(43) Pub. Date: Sep. 4, 2008

(54) Automatic video program recording in an interactive television environment

(75) Inventors: Donald Gordon, Mountain View, CA (US); Lena Y. Pavlovskaia, Cupertino, CA (US); Donald J. Fossgreen, Scotts Valley, CA (US); Airan Landau, San Jose, CA (US)

Correspondence Address: BROMBERG & SUNSTEIN LLP, 125 SUMMER STREET, BOSTON, MA, 02110-1618, US

(73) Assignee: ICTV, Inc., San Jose, CA (US)

(21) Appl. No.: 12/012,491

(22) Filed: Feb. 1, 2008

Related U.S. Application Data
(63) Continuation-in-part of application No. 12/008,697, filed on Jan. 11, 2008.
Application No. 12/008,697 is a continuation-in-part of application No. 12/008,722, filed on Jan. 11, 2008.
(60) Provisional application No. 60/884,773, filed on Jan. 12, 2007.
(60) Provisional application No. 60/884,744, filed on Jan. 12, 2007.
(60) Provisional application No. 60/884,772, filed on Jan. 12, 2007.
(60) Provisional application No. 60/884,773, filed on Jan. 12, 2007.
(60) Provisional application No. 60/884,744, filed on Jan. 12, 2007.
(60) Provisional application No. 60/884,772, filed on Jan. 12, 2007.

(51) Int. Cl. H04N 7/26

(52) U.S. Cl. 386/124

(57) ABSTRACT

Systems and methods for recording a broadcast video program are disclosed. The system is coupled to a television of a user. The broadcast video program is displayed on the user's television and includes associated user selectable material. The system has an input for receiving the broadcast video program and the associated selectable material. A user interface device operates with the system allowing a user to select the selectable material. In response to selection of the selectable material, a processing module requests interactive content related to the selectable material from a processing office. In response to the selection of the selectable material, the system causes a video recorder to automatically begin recording of the broadcast video program. The interactive content is then displayed on the user's television. When the user has finished interacting with the interactive content, the recorded video program is retrieved and displayed on the user's television at the point in the video program when the selectable material was requested.

### CROSS-REFERENCE TO RELATED APPLICATIONS

The present U.S. Patent Application is a Continuation-In-Part of and claims priority from U.S. patent application Ser. No. 12/008,722 entitled “MPEG Objects and Systems and Methods for Using MPEG Objects” filed on Jan. 11, 2008, which itself claims priority from U.S. Provisional Patent Applications No. 60/884,744, No.: 60/884,772, and No. 60/884,773, each of which was filed on Jan. 12, 2007. The subject matter of these applications is incorporated herein by reference in their entirety. The present U.S. Patent Application is also a Continuation-In-Part of and claims priority from U.S. patent application Ser. No. 12/008,697 entitled “Interactive Encoded Content System including Object Models for Viewing on a Remote Device” filed on Jan. 11, 2008, which itself claims priority from U.S. Provisional Patent Applications No. 60/884,744, No.: 60/884,772, and No. 60/884,773, each of which was filed on Jan. 12, 2007. The subject matter of these applications is incorporated herein by reference in their entirety.

### TECHNICAL FIELD AND BACKGROUND ART

The present invention relates to systems and methods for providing interactive content in conjunction with broadcast content to a remote device wherein when the interactive content is selected, the broadcast content is recorded for playback on a display device associated with the remote device.

In cable television systems, the cable head-end transmits content to one or more subscribers wherein the content is transmitted in an encoded form. Typically, the content is encoded as digital MPEG video and each subscriber has a set-top box or cable card that is capable of decoding the MPEG video stream. Beyond providing linear content, cable providers can now provide interactive content, such as web pages or walled-garden content. As the Internet has become more dynamic, including video content on web pages and requiring applications or scripts for decoding the video content, cable providers have adapted to allow subscribers the ability to view these dynamic web pages. In order to composite a dynamic web page for transmission to a requesting subscriber in encoded form, the cable head end retrieves the requested web page and renders the web page. Thus, the cable headend must first decode any encoded content that appears within the dynamic webpage. For example, if a video is to be played on the webpage, the headend must retrieve the encoded video and decode each frame of the video. The cable headend then renders each frame to form a sequence of bitmap images of the Internet web page. Thus, the web page can only be composited together if all of the content that forms the web page is first decoded. Once the composite frames are complete, the composited video is sent to an encoder, such as an MPEG encoder to be re-encoded. The compressed MPEG video frames are then sent in an MPEG video stream to the user's set-top box.

Creating such composite encoded video frames in a cable television network requires intensive CPU and memory processing, since all encoded content must first be decoded, then composited, rendered, and re-encoded. In particular, the cable headend must decode and re-encode all of the content in real-time. Thus, allowing users to operate in an interactive environment with dynamic web pages is quite costly to cable operators because of the required processing. Additionally, such systems have the additional drawback that the image quality is degraded due to re-encoding of the encoded video.

### SUMMARY OF THE INVENTION

Embodiments of the invention disclose a system for encoding at least one composite encoded video frame for display on a display device. The system includes a markup language-based graphical layout, the graphical layout including frame locations within the composite frame for at least the first encoded source and the second encoded source. Additionally, the system has a stitcher module for stitching together the first encoded source and the second encoded source according to the frame locations of the graphical layout. The stitcher forms an encoded frame without having to decode the block-based transform encoded data for at least the first source. The encoded video may be encoded using one of the MPEG standards, AVS, VC-1 or another block-based encoding protocol.

In certain embodiments of the invention, the system allows a user to interact with graphical elements on a display device. The processor maintains state information about one or more graphical elements identified in the graphical layout. The graphical elements in the graphical layout are associated with one of the encoded sources. A user transmits a request to change state of one of the graphical elements through a client device in communication with the system. The request for the change in state causes the processor to register the change in state and to obtain a new encoded source. The processor causes the stitcher to stitch the new encoded source in place of the encoded source representing the graphic element. The processor may also execute or interpret computer code associated with the graphic element.

For example, the graphic element may be a button object that has a plurality of states, associated encoded content for each state, and methods associated which each of the states. The system may also include a transmitter for transmitting to the client device the composited video content. The client device can then decode the composited video content and cause the composited video content to be displayed on a display device. In certain embodiments each graphical element within the graphical layout is associated with one or more encoded MPEG video frames or portions of a video frame, such as one or more macroblocks or slices. The compositor may use a single graphical element repeatedly within the MPEG video stream. For example, the button may be only a single video frame in one state and a single video frame in another state and the button may be composited together with MPEG encoded video content wherein the encoded macroblocks representing the button are stitched into the MPEG encoded video content in each frame.

Other embodiments of the invention disclose a system for creating one or more composite MPEG video frames forming an MPEG video stream. The MPEG video stream is provided to a client device that includes an MPEG decoder. The client device decodes the MPEG video stream and outputs the video to a display device. The composite MPEG video frames are created by obtaining a graphical layout for a video frame. The graphical layout includes frame locations within the composite MPEG video frame for at least a first MPEG source and a second MPEG source. Based upon the graphical layout the first and second MPEG sources are obtained. The first and second MPEG sources are provided to a stitcher module. The stitcher module stitches together the first MPEG source and the second MPEG source according to the frame locations of the graphical layout to form an MPEG frame without having to decode the macroblock data of the MPEG sources. In certain embodiments, the MPEG sources are only decoded to the slice layer and a processor maintains the positions of the slices within the frame for the first and second MPEG sources. This process is repeated for each frame of MPEG data in order to form an MPEG video stream.

In certain embodiments, the system includes a groomer. The groomer grooms the MPEG sources so that each MPEG element of the MPEG source is converted to an MPEG P-frame format. The groomer module may also identify any macroblocks in the second MPEG source that include motion vectors that reference other macroblocks in a section of the first MPEG source and re-encodes those macroblocks as intracoded macroblocks.

The system may include an association between an MPEG source and a method for the MPEG source forming an MPEG object. In such a system, a processor would receive a request from a client device and in response to the request, a method of the MPEG object would be used. The method may change the state of the MPEG object and cause the selection of a different MPEG source. Thus, the stitcher may replace a first MPEG source with a third MPEG source and stitch together the third and second MPEG sources to form a video frame. The video frame would be streamed to the client device and the client device could decode the updated MPEG video frame and display the updated material on the client's display. For. example, an MPEG button object may have an “on” state and an “off” state and the MPEG button object may also include two MPEG graphics composed of a plurality of macroblocks forming slices. In response to a client requesting to change the state of the button from off to on, a method would update the state and cause the MPEG encoded graphic representing an “on” button to be passed to the stitcher.

In certain embodiments, the video frame may be constructed from an unencoded graphic or a graphic that is not MPEG encoded and a groomed MPEG video source. The unencoded graphic may first be rendered. For example, a background may be rendered as a bit map. The background may then be encoded as a series of MPEG macroblocks divided up into slices. The stitcher can then stitch together the background and the groomed MPEG video content to form an MPEG video stream. The background may then be saved for later reuse. In such a configuration, the background would have cut-out regions wherein the slices in those regions would have no associated data, thus video content slices could be inserted into the cut-out. In other embodiments, real-time broadcasts may be received and groomed for creating MPEG video streams.

In certain embodiments, a digital video recorder (DVR) is associated with or part of the client device. In such embodiments, automatic recording may occur when a user of the system selects selectable material while watching a broadcast video program. Selectable material may be part of a video program frame or may be a separate frame(s) inserted between frames of the video program. For example, a television screen may include both a video program and selectable material, such as an advertisement. In other embodiments, an advertisement may be interspersed within the broadcast video program. The client device includes a processing module that can receive a user selection from a user interface device indicating that the user has selected interactive content. The processing module communicates with the processing office to retrieve the interactive content. The interactive content, such as content associated with the advertisement will be presented to the user. For example, if an advertisement for a car is shown along with the video program, the user may select the advertisement for the car and the user may be provided with an interactive screen for pricing and configuring the car. The broadcast video program is no longer displayed on the user's television and the interactive content replaces the video program.

The DVR records the video program when the interactive content is presented to the user through the client device. The client device includes an input for receiving communications from the processing office and sending requests to the processing office. When the processing module of the client device receives a signal from the user interface to exit the interactive content, the processing module causes the video recorder to begin playback of the recorded video program on the user's television. Thus, the user does not miss any portion of the video program by switching to the interactive content. The video program and the selectable material may be constructed as MPEG objects and transmitted to the client device as MPEG elements in an MPEG stream. Similarly, the interactive content associated with the selectable material may also be composed of a plurality of MPEG objects. The processing office maintains state information regarding the MPEG objects.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing a communications environment for implementing one version of the present invention;

FIG. 1A shows the regional processing offices and the video content distribution network;

FIG. 1B is a sample composite stream presentation and interaction layout file;

FIG. 1C shows the construction of a frame within the authoring environment;

FIG. 1D shows breakdown of a frame by macroblocks into elements;

FIG. 2 is a diagram showing multiple sources composited onto a display;

FIG. 3 is a diagram of a system incorporating grooming;

FIG. 4 is a diagram showing a video frame prior to grooming, after grooming, and with a video overlay in the groomed section;

FIG. 5 is a diagram showing how grooming is done, for example, removal of B-frames;

FIG. 6 is a diagram showing an MPEG frame structure;

FIG. 7 is a flow chart showing the grooming process for I, B, and P frames;

FIG. 8 is a diagram depicting removal of region boundary motion vectors;

FIG. 9 is a diagram showing the reordering of the DCT coefficients;

FIG. 10 shows an alternative groomer;

FIG. 11 shows an environment for a stitcher module;

FIG. 12 is a diagram showing video frames starting in random positions relative to each other;

FIG. 13 is a diagram of a display with multiple MPEG elements composited within the picture;

FIG. 14 is a diagram showing the slice breakdown of a picture consisting of multiple elements;

FIG. 15 is a diagram showing slice based encoding in preparation for stitching;

FIG. 16 is a diagram detailing the compositing of a video element into a picture;

FIG. 17 is a diagram detailing compositing of a 16×16 sized macroblock element into a background comprised of 24×24 sized macroblocks;

FIG. 18 is a diagram depicting elements of a frame;

FIG. 19 is a flowchart depicting compositing multiple encoded elements;

FIG. 20 is a diagram showing that the composited element does not need to be rectangular nor contiguous;

FIG. 21 shows a diagram of elements on a screen wherein a single element is non-contiguous;

FIG. 22 shows a groomer for grooming linear broadcast content for multicasting to a plurality of processing offices and/or session processors;

FIG. 23 shows an example of a customized mosaic when displayed on a display device;

FIG. 24 is a diagram of an IP based network for providing interactive MPEG content;

FIG. 24A shows MPEG content displayed on a television along with selectable content;

FIG. 24B shows the interactive content screen after a user has selected the interactive content;

FIG. 24C shows a screen of the video program wherein the DVR begins playback of the content at the point in the video program when the user selected the selectable video content;

FIG. 24D is a flow chart of the process for automatic digital video recording when a user selects selectable material, such as that shown in FIG. 24A;

FIG. 24E is a flow chart that continues the flow chart of FIG. 24D;

FIG. 25 is a diagram of a cable based network for providing interactive MPEG content;

FIG. 26 is a flow-chart of the resource allocation process for a load balancer for use with a cable based network;

FIG. 27 is a system diagram used to show communication between cable network elements for load balancing; and

FIG. 28 shows a client device and an associated digital video recorder.

### DETAILED DESCRIPTION OF SPECIFIC EMBODIMENTS

As used in the following detailed description and in the appended claims the term “region” shall mean a logical grouping of MPEG (Motion Picture Expert Group) slices that are either contiguous or non-contiguous. When the term MPEG is used it shall refer to all variants of the MPEG standard including MPEG-2 and MPEG-4. The present invention as described in the embodiments below provides an environment for interactive MPEG content and communications between a processing office and a client device having an associated display, such as a television. Although the present invention specifically references the MPEG specification and encoding, principles of the invention may be employed with other encoding techniques that are based upon block-based transforms. As used in the following specification and appended claims, the terms encode, encoded, and encoding shall refer to the process of compressing a digital data signal and formatting the compressed digital data signal to a protocol or standard. Encoded video data can be in any state other than a spatial representation. For example, encoded video data may be transform coded, quantized, and entropy encoded or any combination thereof. Therefore, data that has been transform coded will be considered to be encoded.

Although the present application refers to the display device as a television, the display device may be a cell phone, a Personal Digital Assistant (PDA) or other device that includes a display. A client device including a decoding device, such as a set-top box that can decode MPEG content, is associated with the display device of the user. In certain embodiments, the decoder may be part of the display device. The interactive MPEG content is created in an authoring environment allowing an application designer to design the interactive MPEG content creating an application having one or more scenes from various elements including video content from content providers and linear broadcasters. An application file is formed in an Active Video Markup Language (AVML). The AVML file produced by the authoring environment is an XML-based file defining the video graphical elements (i.e. MPEG slices) within a single frame/page, the sizes of the video graphical elements, the layout of the video graphical elements within the page/frame for each scene, links to the video graphical elements, and any scripts for the scene. In certain embodiments, an AVML file may be authored directly as opposed to being authored in a text editor or generated by an authoring environment. The video graphical elements may be static graphics, dynamic graphics, or video content. It should be recognized that each element within a scene is really a sequence of images and a static graphic is an image that is repeatedly displayed and does not change over time. Each of the elements may be an MPEG object that can include both MPEG data for graphics and operations associated with the graphics. The interactive MPEG content can include multiple interactive MPEG objects within a scene with which a user can interact. For example, the scene may include a button MPEG object that provides encoded MPEG data forming the video graphic for the object and also includes a procedure for keeping track of the button state. The MPEG objects may work in coordination with the scripts. For example, an MPEG button object may keep track of its state (on/off), but a script within the scene will determine what occurs when that button is pressed. The script may associate the button state with a video program so that the button will indicate whether the video content is playing or stopped. MPEG objects always have an associated action as part of the object. In certain embodiments, the MPEG objects, such as a button MPEG object, may perform actions beyond keeping track of the status of the button. In such, embodiments, the MPEG object may also include a call to an external program, wherein the MPEG object will access the program when the button graphic is engaged. Thus, for a play/pause MPEG object button, the MPEG object may include code that keeps track of the state of the button, provides a graphical overlay based upon a state change, and/or causes a video player object to play or pause the video content depending on the state of the button.

Once an application is created within the authoring environment, and an interactive session is requested by a requesting client device, the processing office assigns a processor for the interactive session.

The assigned processor operational at the processing office runs a virtual machine and accesses and runs the requested application. The processor prepares the graphical part of the scene for transmission in the MPEG format. Upon receipt of the MPEG transmission by the client device and display on the user's display, a user can interact with the displayed content by using an input device in communication with the client device. The client device sends input requests from the user through a communication network to the application running on the assigned processor at the processing office or other remote location. In response, the assigned processor updates the graphical layout based upon the request and the state of the MPEG objects hereinafter referred to in total as the application state. New elements may be added to the scene or replaced within the scene or a completely new scene may be created. The assigned processor collects the elements and the objects for the scene, and either the assigned processor or another processor processes the data and operations according to the object(s) and produces the revised graphical representation in an MPEG format that is transmitted to the transceiver for display on the user's television. Although the above passage indicates that the assigned processor is located at the processing office, the assigned processor may be located at a remote location and need only be in communication with the processing office through a network connection. Similarly, although the assigned processor is described as handling all transactions with the client device, other processors may also be involved with requests and assembly of the content (MPEG objects) of the graphical layout for the application.

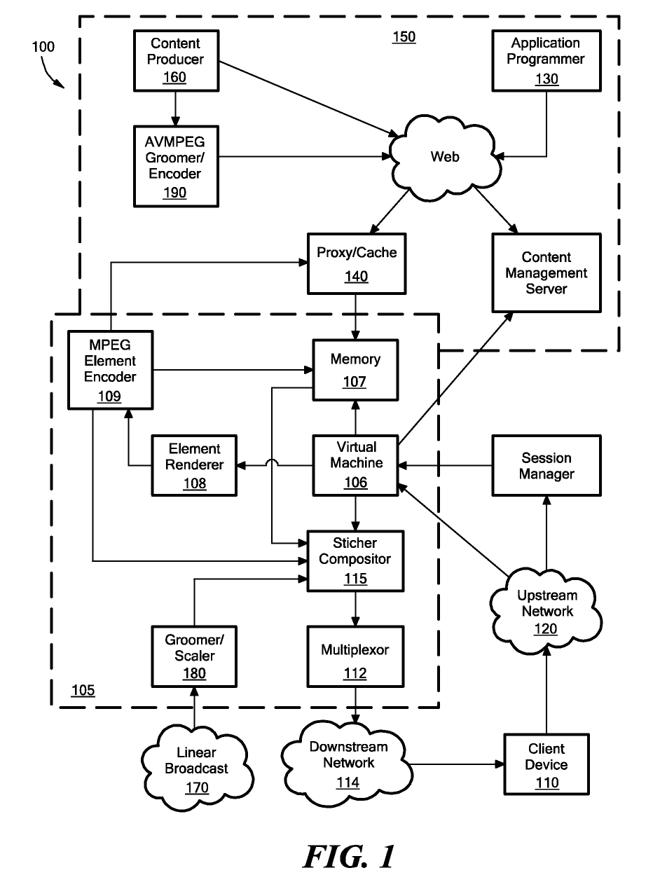

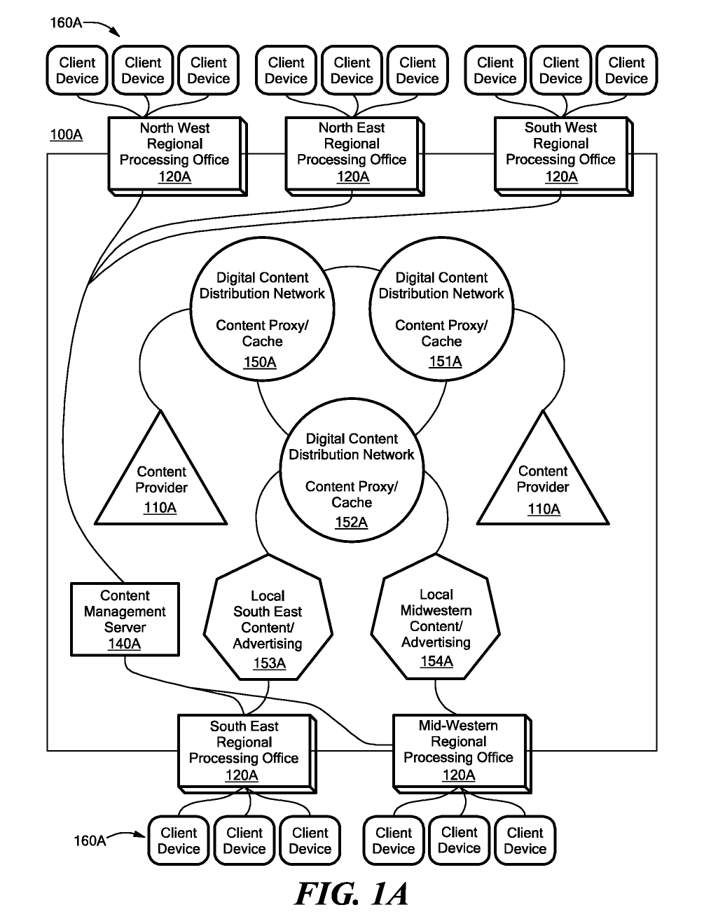

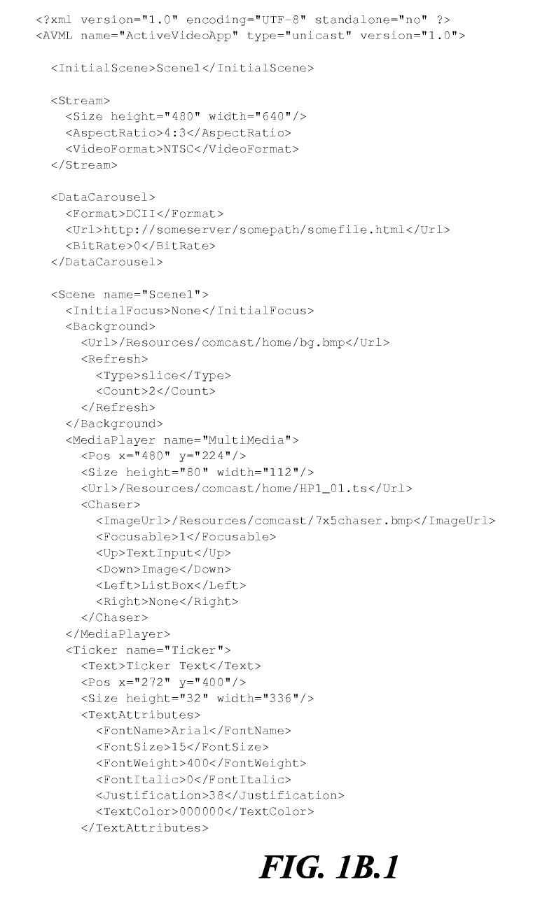

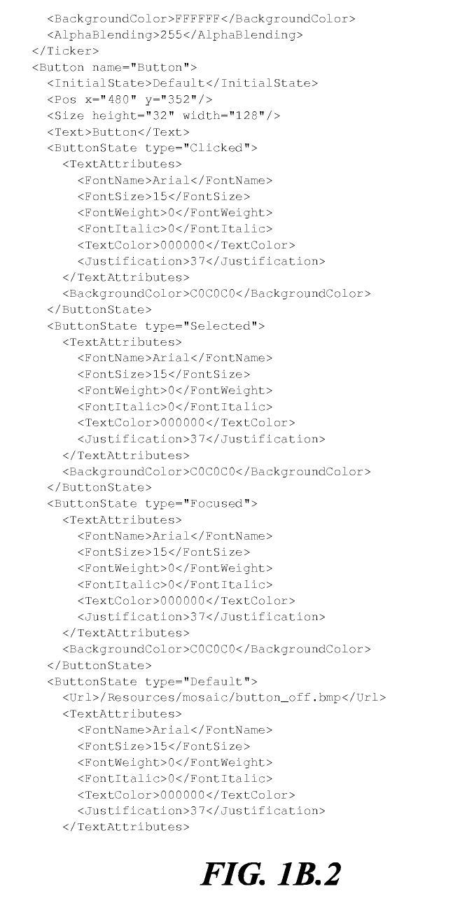

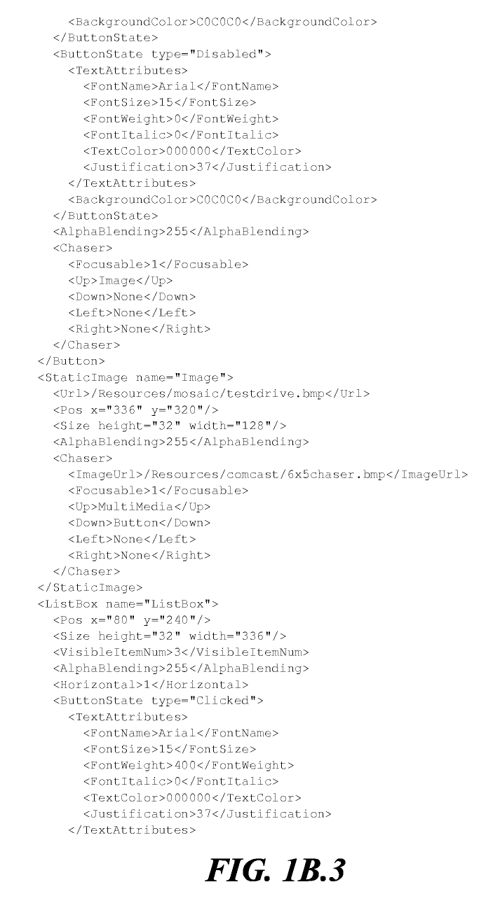

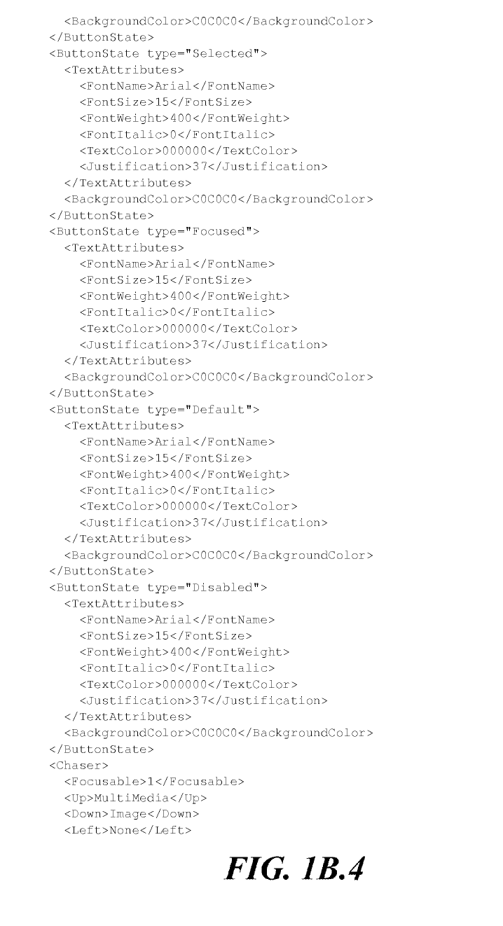

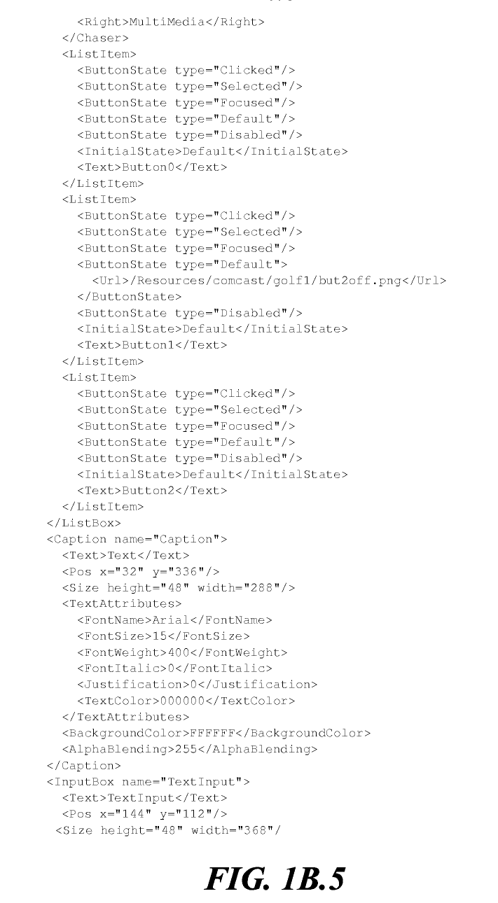

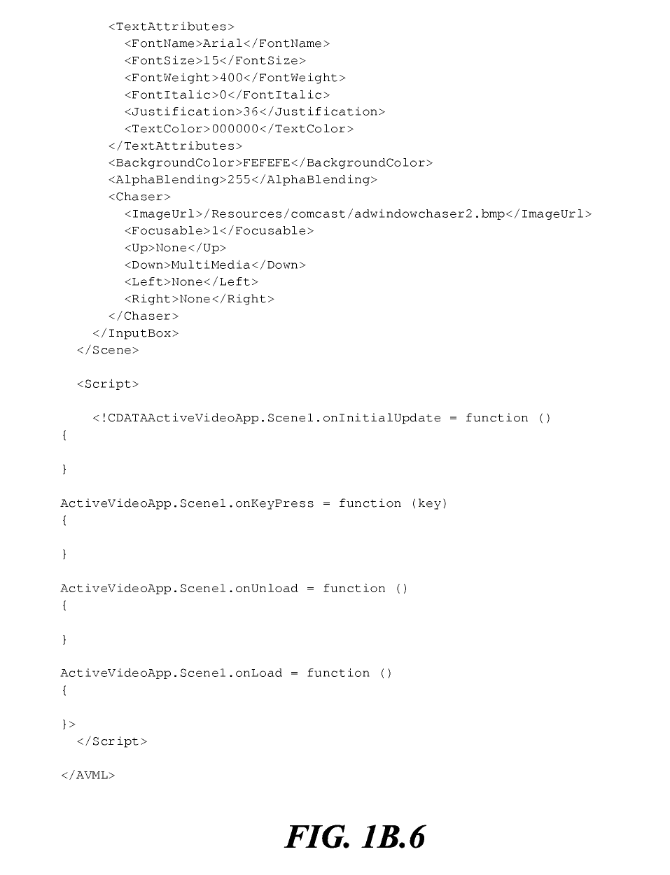

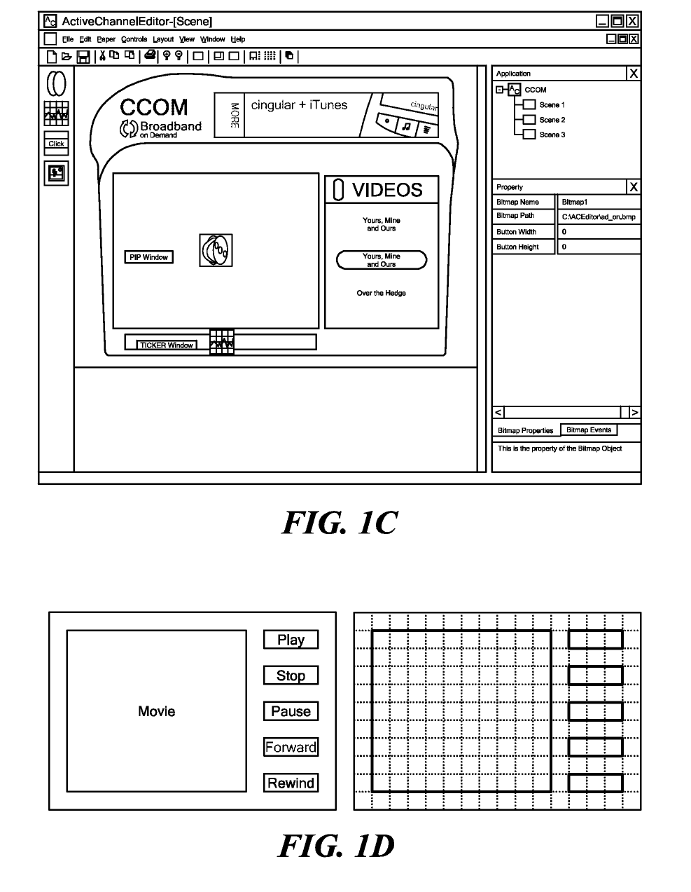

FIG. 1 is a block diagram showing a communications environment 100 for implementing one version of the present invention. The communications environment 100 allows an applications programmer to create an application for two-way interactivity with an end user. The end user views the application on a client device 110, such as a television, and can interact with the content by sending commands upstream through an upstream network 120 wherein upstream and downstream may be part of the same network or a separate network providing the return path link to the processing office. The application programmer creates an application that includes one or more scenes. Each scene is the equivalent of an HTML webpage except that each element within the scene is a video sequence. The application programmer designs the graphical representation of the scene and incorporates links to elements, such as audio and video files and objects, such as buttons and controls for the scene. The application programmer uses a graphical authoring tool 130 to graphically select the objects and elements. The authoring environment 130 may include a graphical interface that allows an application programmer to associate methods with elements creating video objects. The graphics may be MPEG encoded video, groomed MPEG video, still images or video in another format. The application programmer can incorporate content from a number of sources including content providers 160 (news sources, movie studios, RSS feeds etc.) and linear broadcast sources (broadcast media and cable, on demand video sources and web-based video sources) 170 into an application. The application programmer creates the application as a file in AVML (active video mark-up language) and sends the application file to a proxy/cache 140 within a video content distribution network 150. The AVML file format is an XML format. For example see FIG. 1B that shows a sample AVML file.

The content provider 160 may encode the video content as MPEG video/audio or the content may be in another graphical format (e.g. JPEG, BITMAP, H263, H264, VC-1 etc.). The content may be subsequently groomed and/or scaled in a Groomer/Scaler 190 to place the content into a preferable encoded MPEG format that will allow for stitching. If the content is not placed into the preferable MPEG format, the processing office will groom the format when an application that requires the content is requested by a client device. Linear broadcast content 170 from broadcast media services, like content from the content providers, will be groomed. The linear broadcast content is preferably groomed and/or scaled in Groomer/Scaler 180 that encodes the content in the preferable MPEG format for stitching prior to passing the content to the processing office.

The video content from the content producers 160 along with the applications created by application programmers are distributed through a video content distribution network 150 and are stored at distribution points 140. These distribution points are represented as the proxy/cache within FIG. 1. Content providers place their content for use with the interactive processing office in the video content distribution network at a proxy/cache 140 location. Thus, content providers 160 can provide their content to the cache 140 of the video content distribution network 150 and one or more processing office that implements the present architecture may access the content through the video content distribution network 150 when needed for an application. The video content distribution network 150 may be a local network, a regional network or a global network. Thus, when a virtual machine at a processing office requests an application, the application can be retrieved from one of the distribution points and the content as defined within the application's AVML file can be retrieved from the same or a different distribution point.

An end user of the system can request an interactive session by sending a command through the client device 110, such as a set-top box, to a processing office 105. In FIG. 1, only a single processing office is shown. However, in real-world applications, there may be a plurality of processing offices located in different regions, wherein each of the processing offices is in communication with a video content distribution network as shown in FIG. 1B. The processing office 105 assigns a processor for the end user for an interactive session. The processor maintains the session including all addressing and resource allocation. As used in the specification and the appended claims the term “virtual machine” 106 shall refer to the assigned processor, as well as, other processors at the processing office that perform functions, such as session management between the processing office and the client device as well as resource allocation (i.e. assignment of a processor for an interactive session).

The virtual machine 106 communicates its address to the client device 110 and an interactive session is established. The user can then request presentation of an interactive application (AVML) through the client device 110. The request is received by the virtual machine 106 and in response, the virtual machine 106 causes the AVML file to be retrieved from the proxy/cache 140 and installed into a memory cache 107 that is accessible by the virtual machine 106. It should be recognized that the virtual machine 106 may be in simultaneous communication with a plurality of client devices 110 and the client devices may be different device types. For example, a first device may be a cellular telephone, a second device may be a set-top box, and a third device may be a personal digital assistant wherein each device access the same or a different application.

In response to a request for an application, the virtual machine 106 processes the application and requests elements and MPEG objects that are part of the scene to be moved from the proxy/cache into memory 107 associated with the virtual machine 106. An MPEG object includes both a visual component and an actionable component. The visual component may be encoded as one or more MPEG slices or provided in another graphical format. The actionable component may be storing the state of the object, may include performing computations, accessing an associated program, or displaying overlay graphics to identify the graphical component as active. An overlay graphic may be produced by a signal being transmitted to a client device wherein the client device creates a graphic in the overlay plane on the display device. It should be recognized that a scene is not a static graphic, but rather includes a plurality of video frames wherein the content of the frames can change over time.

The virtual machine 106 determines based upon the scene information, including the application state, the size and location of the various elements and objects for a scene. Each graphical element may be formed from contiguous or non-contiguous MPEG slices. The virtual machine keeps track of the location of all of the slices for each graphical element. All of the slices that define a graphical element form a region. The virtual machine 106 keeps track of each region. Based on the display position information within the AVML file, the slice positions for the elements and background within a video frame are set. If the graphical elements are not already in a groomed format, the virtual machine passes that element to an element renderer. The renderer renders the graphical element as a bitmap and the renderer passes the bitmap to an MPEG element encoder 109. The MPEG element encoder encodes the bitmap as an MPEG video sequence. The MPEG encoder processes the bitmap so that it outputs a series of P-frames. An example of content that is not already pre-encoded and pre-groomed is personalized content. For example, if a user has stored music files at the processing office and the graphic element to be presented is a listing of the user's music files, this graphic would be created in real-time as a bitmap by the virtual machine. The virtual machine would pass the bitmap to the element renderer 108 which would render the bitmap and pass the bitmap to the MPEG element encoder 109 for grooming.

After the graphical elements are groomed by the MPEG element encoder, the MPEG element encoder 109 passes the graphical elements to memory 107 for later retrieval by the virtual machine 106 for other interactive sessions by other users. The MPEG encoder 109 also passes the MPEG encoded graphical elements to the stitcher 115. The rendering of an element and MPEG encoding of an element may be accomplished in the same or a separate processor from the virtual machine 106. The virtual machine 106 also determines if there are any scripts within the application that need to be interpreted. If there are scripts, the scripts are interpreted by the virtual machine 106.

Each scene in an application can include a plurality of elements including static graphics, object graphics that change based upon user interaction, and video content. For example, a scene may include a background (static graphic), along with a media player for playback of audio video and multimedia content (object graphic) having a plurality of buttons, and a video content window (video content) for displaying the streaming video content. Each button of the media player may itself be a separate object graphic that includes its own associated methods.

The virtual machine 106 acquires each of the graphical elements (background, media player graphic, and video frame) for a frame and determines the location of each element. Once all of the objects and elements (background, video content) are acquired, the elements and graphical objects are passed to the stitcher/compositor 115 along with positioning information for the elements and MPEG objects. The stitcher 115 stitches together each of the elements (video content, buttons, graphics, background) according to the mapping provided by the virtual machine 106. Each of the elements is placed on a macroblock boundary and when stitched together the elements form an MPEG video frame. On a periodic basis all of the elements of a scene frame are encoded to form a reference P-frame in order to refresh the sequence and avoid dropped macroblocks. The MPEG video stream is then transmitted to the address of client device through the down stream network. The process continues for each of the video frames. Although the specification refers to MPEG as the encoding process, other encoding processes may also be used with this system.

The virtual machine 106 or other processor or process at the processing office 105 maintains information about each of the elements and the location of the elements on the screen. The virtual machine 106 also has access to the methods for the objects associated with each of the elements. For example, a media player may have a media player object that includes a plurality of routines. The routines can include, play, stop, fast forward, rewind, and pause. Each of the routines includes code and upon a user sending a request to the processing office 105 for activation of one of the routines, the object is accessed and the routine is run. The routine may be a JAVA-based applet, a script to be interpreted, or a separate computer program capable of being run within the operating system associated with the virtual machine.

The processing office 105 may also create a linked data structure for determining the routine to execute or interpret based upon a signal received by the processor from the client device associated with the television. The linked data structure may be formed by an included mapping module. The data structure associates each resource and associated object relative to every other resource and object. For example, if a user has already engaged the play control, a media player object is activated and the video content is displayed. As the video content is playing in a media player window, the user can depress a directional key on the user's remote control. In this example, the depression of the directional key is indicative of pressing a stop button. The transceiver produces a directional signal and the assigned processor receives the directional signal. The virtual machine 106 or other processor at the processing office 105 accesses the linked data structure and locates the element in the direction of the directional key press. The database indicates that the element is a stop button that is part of a media player object and the processor implements the routine for stopping the video content. The routine will cause the requested content to stop. The last video content frame will be frozen and a depressed stop button graphic will be interwoven by the stitcher module into the frame. The routine may also include a focus graphic to provide focus around the stop button. For example, the virtual machine can cause the stitcher to enclose the graphic having focus with a boarder that is 1 macroblock wide. Thus, when the video frame is decoded and displayed, the user will be able to identify the graphic/object that the user can interact with. The frame will then be passed to a multiplexor and sent through the downstream network to the client device. The MPEG encoded video frame is decoded by the client device displayed on either the client device (cell phone, PDA) or on a separate display device (monitor, television). This process occurs with a minimal delay. Thus, each scene from an application results in a plurality of video frames each representing a snapshot of the media player application state.

The virtual machine 106 will repeatedly receive commands from the client device and in response to the commands will either directly or indirectly access the objects and execute or interpret the routines of the objects in response to user interaction and application interaction model. In such a system, the video content material displayed on the television of the user is merely decoded MPEG content and all of the processing for the interactivity occurs at the processing office and is orchestrated by the assigned virtual machine. Thus, the client device only needs a decoder and need not cache or process any of the content.

It should be recognized that through user requests from a client device, the processing office could replace a video element with another video element. For example, a user may select from a list of movies to display and therefore a first video content element would be replaced by a second video content element if the user selects to switch between two movies. The virtual machine, which maintains a listing of the location of each element and region forming an element can easily replace elements within a scene creating a new MPEG video frame wherein the frame is stitched together including the new element in the stitcher 115.

FIG. 1A shows the interoperation between the digital content distribution network 100A, the content providers 110A and the processing offices 120A. In this example, the content providers 130A distribute content into the video content distribution network 100A. Either the content providers 130A or processors associated with the video content distribution network convert the content to an MPEG format that is compatible with the processing office's 120A creation of interactive MPEG content. A content management server 140A of the digital content distribution network 100A distributes the MPEG-encoded content among proxy/caches 150A-154A located in different regions if the content is of a global/national scope. If the content is of a regional/local scope, the content will reside in a regional/local proxy/cache. The content may be mirrored throughout the country or world at different locations in order to increase access times. When an end user, through their client device 160A, requests an application from a regional processing office, the regional processing office will access the requested application. The requested application may be located within the video content distribution network or the application may reside locally to the regional processing office or within the network of interconnected processing offices. Once the application is retrieved, the virtual machine assigned at the regional processing office will determine the video content that needs to be retrieved. The content management server 140A assists the virtual machine in locating the content within the video content distribution network. The content management server 140A can determine if the content is located on a regional or local proxy/cache and also locate the nearest proxy/cache. For example, the application may include advertising and the content management server will direct the virtual machine to retrieve the advertising from a local proxy/cache. As shown in FIG. 1A, both the Midwestern and Southeastern regional processing offices 120A also have local proxy/caches 153A, 154A. These proxy/caches may contain local news and local advertising. Thus, the scenes presented to an end user in the Southeast may appear different to an end user in the Midwest. Each end user may be presented with different local news stories or different advertising. Once the content and the application are retrieved, the virtual machine processes the content and creates an MPEG video stream. The MPEG video stream is then directed to the requesting client device. The end user may then interact with the content requesting an updated scene with new content and the virtual machine at the processing office will update the scene by requesting the new video content from the proxy/cache of the video content distribution network.

### Authoring Environment

The authoring environment includes a graphical editor as shown in FIG. 1C for developing interactive applications. An application includes one or more scenes. As shown in FIG. 1B the application window shows that the application is composed of three scenes (scene 1, scene 2 and scene 3). The graphical editor allows a developer to select elements to be placed into the scene forming a display that will eventually be shown on a display device associated with the user. In some embodiments, the elements are dragged-and-dropped into the application window. For example, a developer may want to include a media player object and media player button objects and will select these elements from a toolbar and drag and drop the elements in the window. Once a graphical element is in the window, the developer can select the element and a property window for the element is provided. The property window includes at least the location of the graphical element (address), and the size of the graphical element. If the graphical element is associated with an object, the property window will include a tab that allows the developer to switch to a bitmap event screen and alter the associated object parameters. For example, a user may change the functionality associated with a button or may define a program associated with the button.

As shown in FIG. 1D, the stitcher of the system creates a series of MPEG frames for the scene based upon the AVML file that is the output of the authoring environment. Each element/graphical object within a scene is composed of different slices defining a region. A region defining an element/object may be contiguous or non-contiguous. The system snaps the slices forming the graphics on a macro-block boundary. Each element need not have contiguous slices. For example, the background has a number of non-contiguous slices each composed of a plurality of macroblocks. The background, if it is static, can be defined by intracoded macroblocks. Similarly, graphics for each of the buttons can be intracoded; however the buttons are associated with a state and have multiple possible graphics. For example, the button may have a first state “off” and a second state “on” wherein the first graphic shows an image of a button in a non-depressed state and the second graphic shows the button in a depressed state. FIG. 1C also shows a third graphical element, which is the window for the movie. The movie slices are encoded with a mix of intracoded and intercoded macroblocks and dynamically changes based upon the content. Similarly if the background is dynamic, the background can be encoded with both intracoded and intercoded macroblocks, subject to the requirements below regarding grooming.

When a user selects an application through a client device, the processing office will stitch together the elements in accordance with the layout from the graphical editor of the authoring environment. The output of the authoring environment includes an Active Video Mark-up Language file (AVML) The AVML file provides state information about multi-state elements such as a button, the address of the associated graphic, and the size of the graphic. The AVML file indicates the locations within the MPEG frame for each element, indicates the objects that are associated with each element, and includes the scripts that define changes to the MPEG frame based upon user's actions. For example, a user may send an instruction signal to the processing office and the processing office will use the AVML file to construct a set of new MPEG frames based upon the received instruction signal. A user may want to switch between various video elements and may send an instruction signal to the processing office. The processing office will remove a video element within the layout for a frame and will select the second video element causing the second video element to be stitched into the MPEG frame at the location of the first video element. This process is described below.

### AVML File

The application programming environment outputs an AVML file. The AVML file has an XML-based syntax. The AVML file syntax includes a root object <AVML>. Other top level tags include <initialscene> that specifies the first scene to be loaded when an application starts. The <script> tag identifies a script and a <scene> tag identifies a scene. There may also be lower level tags to each of the top level tags, so that there is a hierarchy for applying the data within the tag. For example, a top level stream tag may include <aspect ratio> for the video stream, <video format>, <bit rate>, <audio format> and <audio bit rate>. Similarly, a scene tag may include each of the elements within the scene. For example, <background> for the background, <button> for a button object, and <static image> for a still graphic. Other tags include <size> and <pos> for the size and position of an element and may be lower level tags for each element within a scene. An example of an AVML file is provided in FIG. 1B. Further discussion of the AVML file syntax is provided in Appendix A attached hereto.

### Groomer

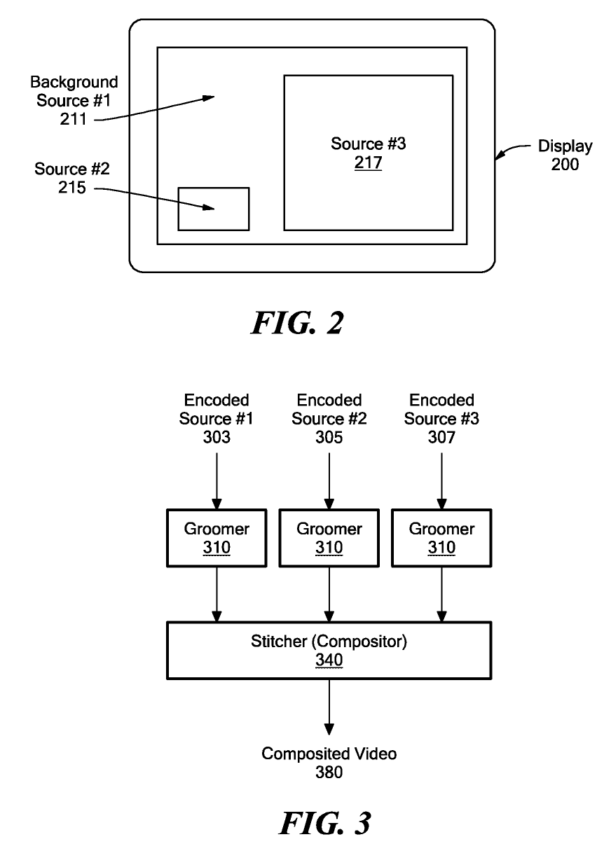

FIG. 2 is a diagram of a representative display that could be provided to a television of a requesting client device. The display 200 shows three separate video content elements appearing on the screen. Element #1 211 is the background in which element #2 215 and element #3 217 are inserted.

FIG. 3 shows a first embodiment of a system that can generate the display of FIG. 2. In this diagram, the three video content elements come in as encoded video: element #1 303, element #2 305, and element #3 307. The groomers 310 each receive an encoded video content element and the groomers process each element before the stitcher 340 combines the groomed video content elements into a single composited video 380. It should be understood by one of ordinary skill in the art that groomers 310 may be a single processor or multiple processors that operate in parallel. The groomers may be located either within the processing office, at content providers' facilities, or linear broadcast provider's facilities. The groomers may not be directly connected to the stitcher, as shown in FIG. 1 wherein the groomers 190 and 180 are not directly coupled to stitcher 115.

The process of stitching is described below and can be performed in a much more efficient manner if the elements have been groomed first.

Grooming removes some of the interdependencies present in compressed video. The groomer will convert I and B frames to P frames and will fix any stray motion vectors that reference a section of another frame of video that has been cropped or removed. Thus, a groomed video stream can be used in combination with other groomed video streams and encoded still images to form a composite MPEG video stream. Each groomed video stream includes a plurality of frames and the frames can be can be easily inserted into another groomed frame wherein the composite frames are grouped together to form an MPEG video stream. It should be noted that the groomed frames may be formed from one or more MPEG slices and may be smaller in size than an MPEG video frame in the MPEG video stream.

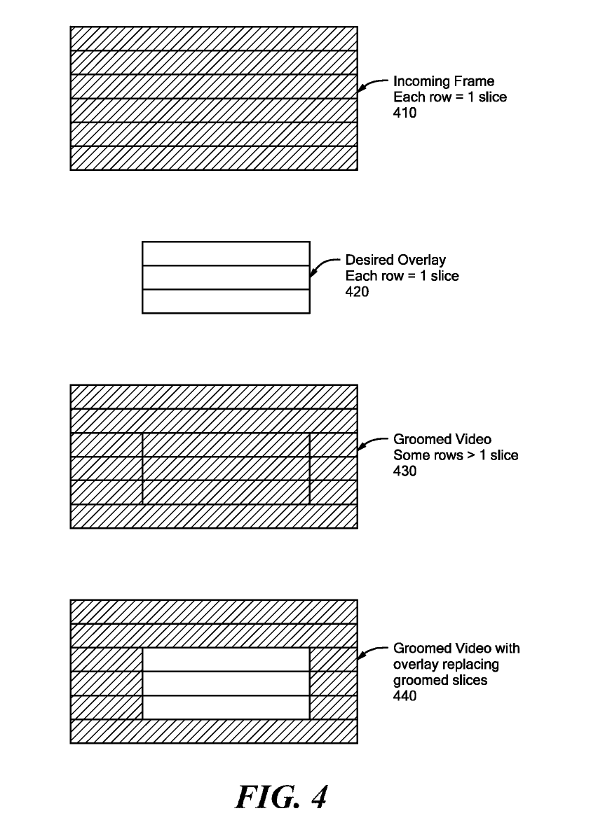

FIG. 4 is an example of a composite video frame that contains a plurality of elements 410, 420. This composite video frame is provided for illustrative purposes. The groomers as shown in FIG. 1 only receive a single element and groom the element (video sequence), so that the video sequence can be stitched together in the stitcher. The groomers do not receive a plurality of elements simultaneously. In this example, the background video frame 410 includes 1 row per slice (this is an example only; the row could be composed of any number of slices). As shown in FIG. 1, the layout of the video frame including the location of all of the elements within the scene are defined by the application programmer in the AVML file. For example, the application programmer may design the background element for a scene. Thus, the application programmer may have the background encoded as MPEG video and may groom the background prior to having the background placed into the proxy cache 140. Therefore, when an application is requested, each of the elements within the scene of the application may be groomed video and the groomed video can easily be stitched together. It should be noted that although two groomers are shown within FIG. 1 for the content provider and for the linear broadcasters, groomers may be present in other parts of the system.

As shown, video element 420 is inserted within the background video frame 410 (also for example only; this element could also consist of multiple slices per row). If a macroblock within the original video frame 410 references another macroblock in determining its value and the reference macroblock is removed from the frame because the video image 420 is inserted in its place, the macroblocks value needs to be recalculated. Similarly, if a macroblock references another macroblock in a subsequent frame and that macroblock is removed and other source material is inserted in its place, the macroblock values need to be recalculated. This is addressed by grooming the video 430. The video frame is processed so that the rows contain multiple slices some of which are specifically sized and located to match the substitute video content. After this process is complete, it is a simple task to replace some of the current slices with the overlay video resulting in a groomed video with overlay 440. The groomed video stream has been specifically defined to address that particular overlay. A different overlay would dictate different grooming parameters. Thus, this type of grooming addresses the process of segmenting a video frame into slices in preparation for stitching. It should be noted that there is never a need to add slices to the overlay element. Slices are only added to the receiving element, that is, the element into which the overlay will be placed. The groomed video stream can contain information about the stream's groomed characteristics. Characteristics that can be provided include: 1. the locations for the upper left and lower right corners of the groomed window. 2. The location of upper left corner only and then the size of the window. The size of the slice accurate to the pixel level.

There are also two ways to provide the characteristic information in the video stream. The first is to provide that information in the slice header. The second is to provide the information in the extended data slice structure. Either of these options can be used to successfully pass the necessary information to future processing stages, such as the virtual machine and stitcher.

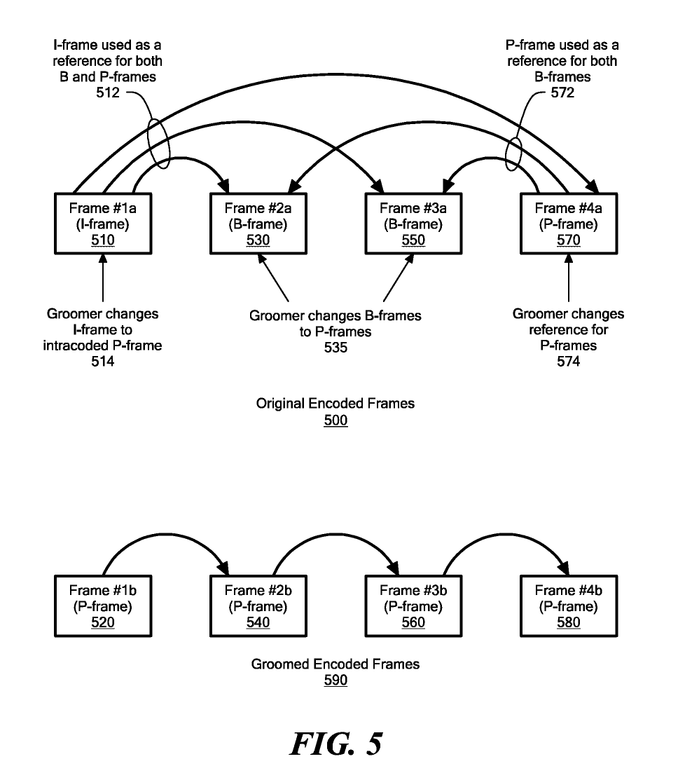

FIG. 5 shows the video sequence for a video graphical element before and after grooming. The original incoming encoded stream 500 has a sequence of MPEG I-frames 510, B-frames 530 550, and P-frames 570 as are known to those of ordinary skill in the art. In this original stream, the I-frame is used as a reference 512 for all the other frames, both B and P. This is shown via the arrows from the I-frame to all the other frames. Also, the P-frame is used as a reference frame 572 for both B-frames. The groomer processes the stream and replaces all the frames with P-frames. First the original I-frame 510 is converted to an intracoded P-frame 520. Next the B-frames 530, 550 are converted 535 to P-frames 540 and 560 and modified to reference only the frame immediately prior. Also, the P-frames 570 are modified to move their reference 574 from the original I-frame 510 to the newly created P-frame 560 immediately in preceding themselves. The resulting P-frame 580 is shown in the output stream of groomed encoded frames 590.

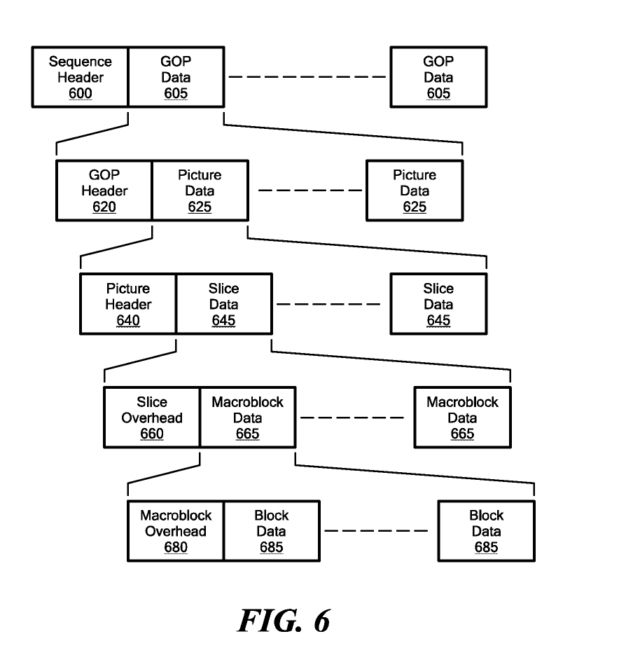

FIG. 6 is a diagram of a standard MPEG-2 bitstream syntax. MPEG-2 is used as an example and the invention should not be viewed as limited to this example. The hierarchical structure of the bitstream starts at the sequence level. This contains the sequence header 600 followed by group of picture (GOP) data 605. The GOP data contains the GOP header 620 followed by picture data 625. The picture data 625 contains the picture header 640 followed by the slice data 645. The slice data 645 consists of some slice overhead 660 followed by macroblock data 665. Finally, the macroblock data 665 consists of some macroblock overhead 680 followed by block data 685 (the block data is broken down further but that is not required for purposes of this reference). Sequence headers act as normal in the groomer. However, there are no GOP headers output of the groomer since all frames are P-frames. The remainder of the headers may be modified to meet the output parameters required.

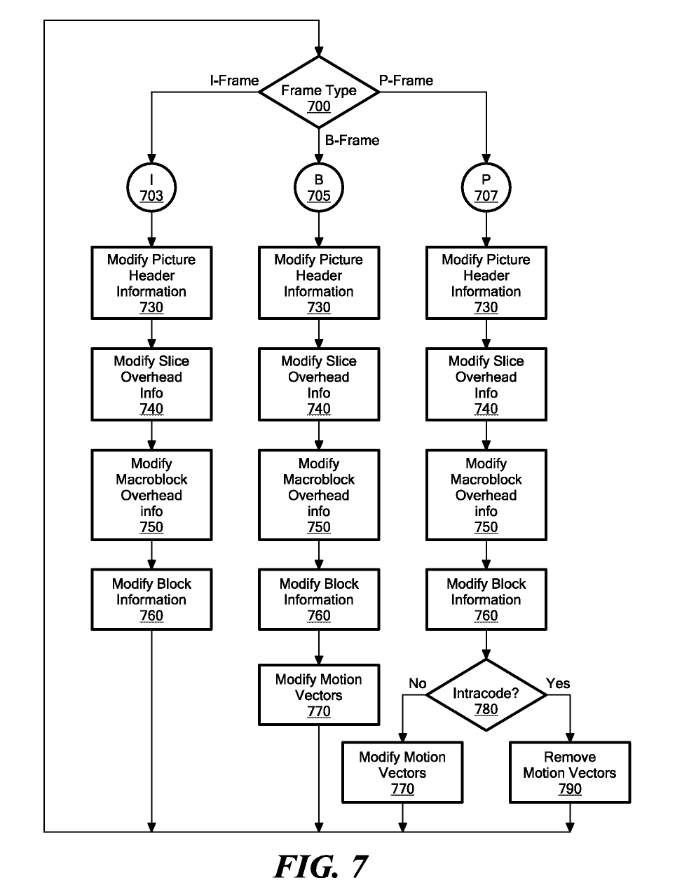

FIG. 7 provides a flow for grooming the video sequence. First the frame type is determining 700: I-frame 703 B-frame 705, or P-frame 707. I-frames 703 as do B-frames 705 need to be converted to P-frames. In addition, I-frames need to match the picture information that the stitcher requires. For example, this information may indicate the encoding parameters set in the picture header. Therefore, the first step is to modify the picture header information 730 so that the information in the picture header is consistent for all groomed video sequences. The stitcher settings are system level settings that may be included in the application. These are the parameters that will be used for all levels of the bit stream. The items that require modification are provided in the table below:

TABLE 1
Picture Header Information

| # | Name | Value |
|---|---|---|
| A | Picture Coding Type | P-Frame |
| B | Intra DC Precision | Match stitcher setting |
| C | Picture structure | Frame |
| D | Frame prediction frame DCT | Match stitcher setting |
| E | Quant scale type | Match stitcher setting |
| F | Intra VLC format | Match stitcher setting |
| G | Alternate scan | Normal scan |
| H | Progressive frame | Progressive scan |

Next, the slice overhead information 740 must be modified. The parameters to modify are given in the table below.

TABLE 2
Slice Overhead Information

| # | Name | Value |
|---|---|---|
| A | Quantizer Scale Code | Will change if there is a “scale type” change |
| | | in the picture header. |

Next, the macroblock overhead 750 information may require modification. The values to be modified are given in the table below.

TABLE 3
Macroblock Information

| # | Name | Value |
|---|---|---|
| A | Macroblock type | Change the variable length code from that for |
| | | an I frame to that for a P frame) |
| B | DCT type | Set to frame if not already |
| C | Concealment motion | Removed |
| | vectors | |

Finally, the block information 760 may require modification. The items to modify are given in the table below.

TABLE 4
Block Information

| # | Name | Value |
|---|---|---|
| A | DCT coefficient values | Require updating if there were any quantizer |
| | | changes at the picture or slice level. |
| B | DCT coefficient | Need to be reordered if “alternate scan” |
| | ordering | was changed from what it was before. |

Once the block changes are complete, the process can start over with the next frame of video.

If the frame type is a B-frame 705, the same steps required for an I-frame are also required for the B-frame. However, in addition, the motion vectors 770 need to be modified. There are two scenarios: B-frame immediately following an I-frame or P-frame, or a B-frame following another B-frame. Should the B-frame follow either an I or P frame, the motion vector, using the I or P frame as a reference, can remain the same and only the residual would need to change. This may be as simple as converting the forward looking motion vector to be the residual.

For the B-frames that follow another B-frame, the motion vector and its residual will both need to be modified. The second B-frame must now reference the newly converted B to P frame immediately preceding it. First, the B-frame and its reference are decoded and the motion vector and the residual are recalculated. It must be noted that while the frame is decoded to update the motion vectors, there is no need to re-encode the DCT coefficients. These remain the same. Only the motion vector and residual are calculated and modified.

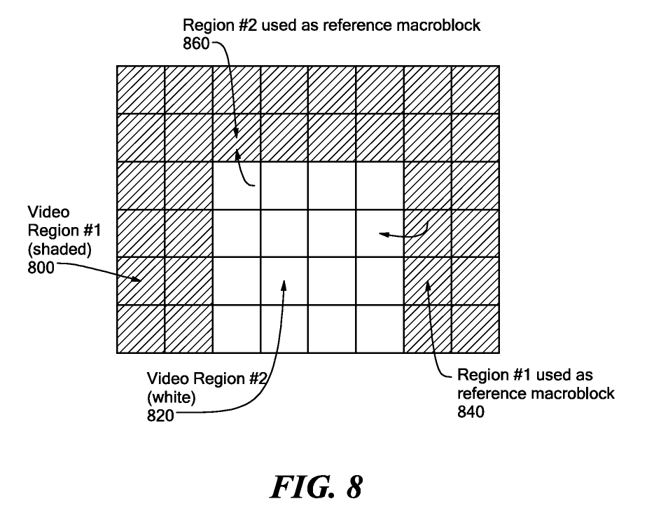

The last frame type is the P-frame. This frame type also follows the same path as an I-frame FIG. 8 diagrams the motion vector modification for macroblocks adjacent to a region boundary. It should be recognized that motion vectors on a region boundary are most relevant to background elements into which other video elements are being inserted. Therefore, grooming of the background elements may be accomplished by the application creator. Similarly, if a video element is cropped and is being inserted into a “hole” in the background element, the cropped element may include motion vectors that point to locations outside of the “hole”. Grooming motion vectors for a cropped image may be done by the content creator if the content creator knows the size that the video element needs to be cropped, or the grooming may be accomplished by the virtual machine in combination with the element renderer and MPEG encoder if the video element to be inserted is larger than the size of the “hole” in the background.

FIG. 8 graphically shows the problems that occur with motion vectors that surround a region that is being removed from a background element. In the example of FIG. 8, the scene includes two regions: #1 800 and #2 820. There are two examples of improper motion vector references. In the first instance, region #2 820 that is inserting into region #1 800 (background), uses region #1 800 (background) as a reference for motion 840. Thus, the motion vectors in region #2 need to be corrected. The second instance of improper motion vector references occurs where region #1 800 uses region #2 820 as a reference for motion 860. The groomer removes these improper motion vector references by either re-encoding them using a frame within the same region or converting the macroblocks to be intracoded blocks.

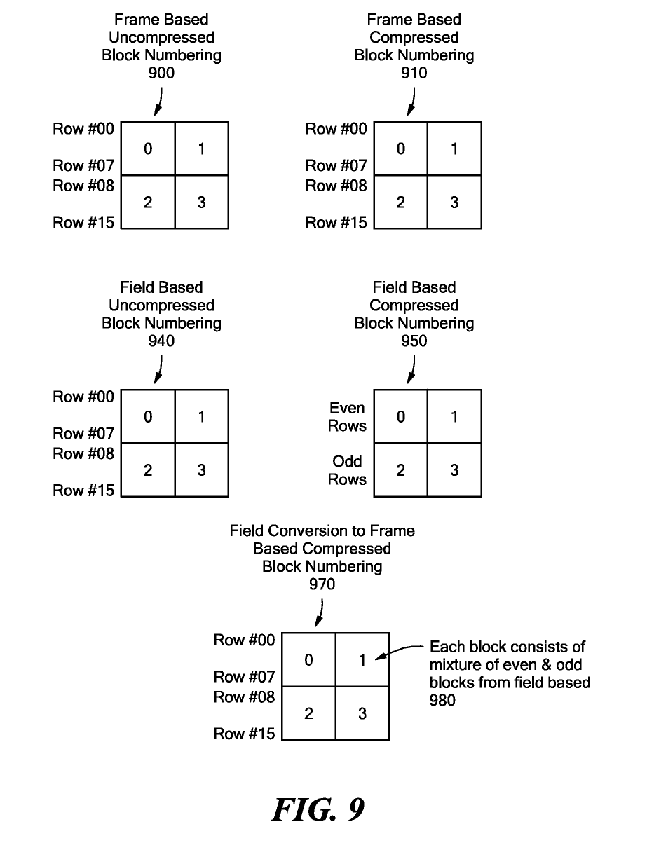

In addition to updating motion vectors and changing frame types, the groomer may also convert field based encoded macroblocks to frame based encoded macroblocks. FIG. 9 shows the conversion of a field based encoded macroblocks to frame based. For reference, a frame based set of blocks 900 is compressed. The compressed block set 910 contains the same information in the same blocks but now it is contained in compressed form. On the other hand, a field based macroblock 940 is also compressed. When this is done, all the even rows (0, 2, 4, 6) are placed in the upper blocks (0 & 1) while the odd rows (1, 3, 5, 7) are placed in the lower blocks (2&3). When the compressed field based macroblock 950 is converted to a frame based macroblock 970, the coefficients need to be moved from one block to another 980. That is, the rows must be reconstructed in numerical order rather than in even odd. Rows 1 & 3, which in the field based encoding were in blocks 2 & 3, are now moved back up to blocks 0 or 1 respectively. Correspondingly, rows 4 & 6 are moved from blocks 0 & 1 and placed down in blocks 2 & 3.

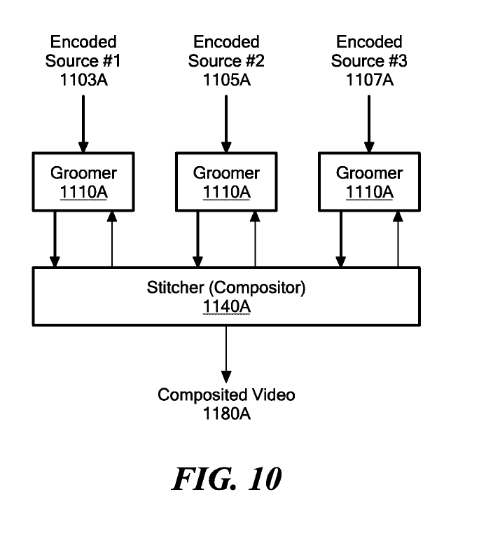

FIG. 10 shows a second embodiment of the grooming platform. All the components are the same as the first embodiment: groomers 1110A and stitcher 1130A. The inputs are also the same: input #1 1103A, input #2 1105A, and input #3 1107A as well as the composited output 1280. The difference in this system is that the stitcher 1140A provides feedback, both synchronization and frame type information, to each of the groomers 1110A. With the synchronization and frame type information, the stitcher 1240 can define a GOP structure that the groomers 1110A follow. With this feedback and the GOP structure, the output of the groomer is no longer P-frames only but can also include I-frames and B-frames. The limitation to an embodiment without feedback is that no groomer would know what type of frame the stitcher was building. In this second embodiment with the feedback from the stitcher 1140A, the groomers 1110A will know what picture type the stitcher is building and so the groomers will provide a matching frame type. This improves the picture quality assuming the same data rate and may decrease the data rate assuming that the quality level is kept constant due to more reference frames and less modification of existing frames while, at the same time, reducing the bit rate since B-frames are allowed.

### Stitcher

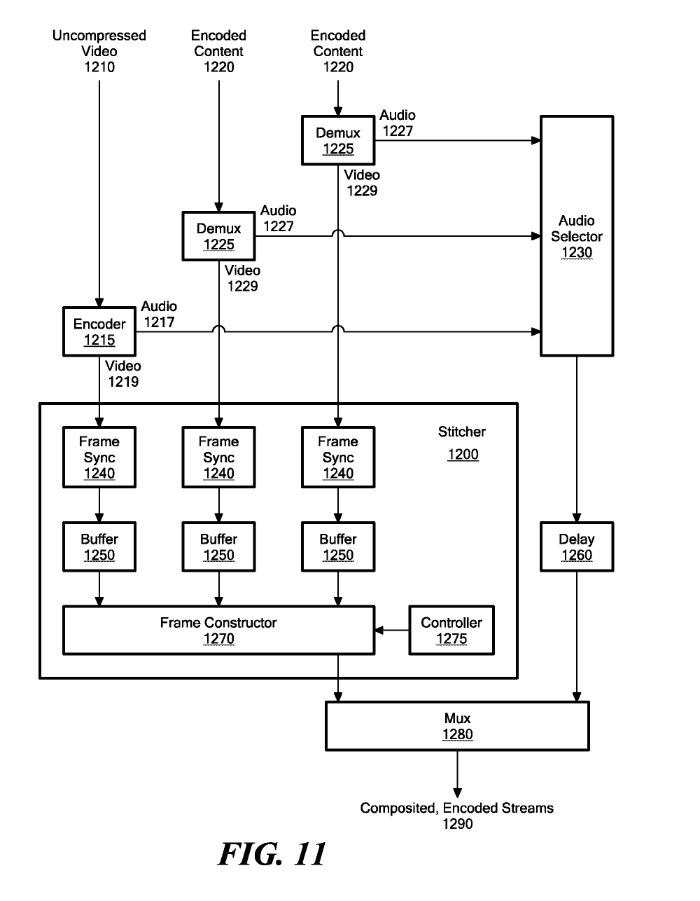

FIG. 11 shows an environment for implementing a stitcher module, such as the stitcher shown in FIG. 1. The stitcher 1200 receives video elements from different sources. Uncompressed content 1210 is encoded in an encoder 1215, such as the MPEG element encoder shown in FIG. 1 prior to its arrival at the stitcher 1200. Compressed or encoded video 1220 does not need to be encoded. There is, however, the need to separate the audio 1217 1227 from the video 1219 1229 in both cases. The audio is fed into an audio selector 1230 to be included in the stream. The video is fed into a frame synchronization block 1240 before it is put into a buffer 1250. The frame constructor 1270 pulls data from the buffers 1250 based on input from the controller 1275. The video out of the frame constructor 1270 is fed into a multiplexer 1280 along with the audio after the audio has been delayed 1260 to align with the video. The multiplexer 1280 combines the audio and video streams and outputs the composited, encoded output streams 1290 that can be played on any standard decoder. Multiplexing a data stream into a program or transport stream is well known to those familiar in the art. The encoded video sources can be real-time, from a stored location, or a combination of both. There is no requirement that all of the sources arrive in real-time.

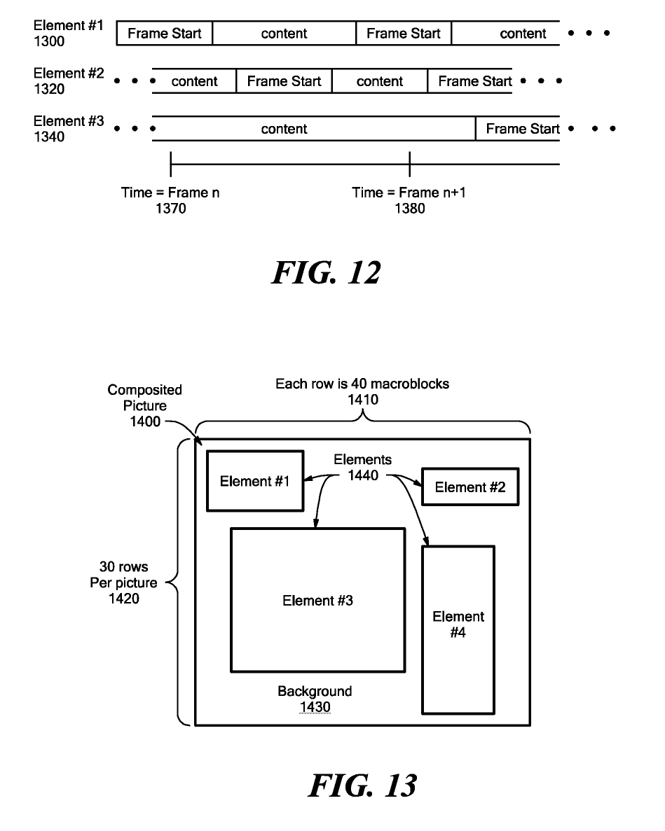

FIG. 12 shows an example of three video content elements that are temporally out of sync. In order to synchronize the three elements, element #1 1300 is used as an “anchor” or “reference” frame. That is, it is used as the master frame and all other frames will be aligned to it (this is for example only; the system could have its own master frame reference separate from any of the incoming video sources). The output frame timing 1370 1380 is set to match the frame timing of element #1 1300. Elements #2 & 3 1320 and 1340 do not align with element #1 1300. Therefore, their frame start is located and they are stored in a buffer. For example, element #2 1320 will be delayed one frame so an entire frame is available before it is composited along with the reference frame. Element #3 is much slower than the reference frame. Element #3 is collected over two frames and presented over two frames. That is, each frame of element #3 1340 is displayed for two consecutive frames in order to match the frame rate of the reference frame. Conversely if a frame, not shown, was running at twice the rate of the reference frame, then every other frame would be dropped (not shown). More than likely all elements are running at almost the same speed so only infrequently would a frame need to be repeated or dropped in order to maintain synchronization.

FIG. 13 shows an example composited video frame 1400. In this example, the frame is made up of 40 macroblocks per row 1410 with 30 rows per picture 1420. The size is used as an example and it not intended to restrict the scope of the invention. The frame includes a background 1430 that has elements 1440 composited in various locations. These elements 1440 can be video elements, static elements, etc. That is, the frame is constructed of a full background, which then has particular areas replaced with different elements. This particular example shows four elements composited on a background.

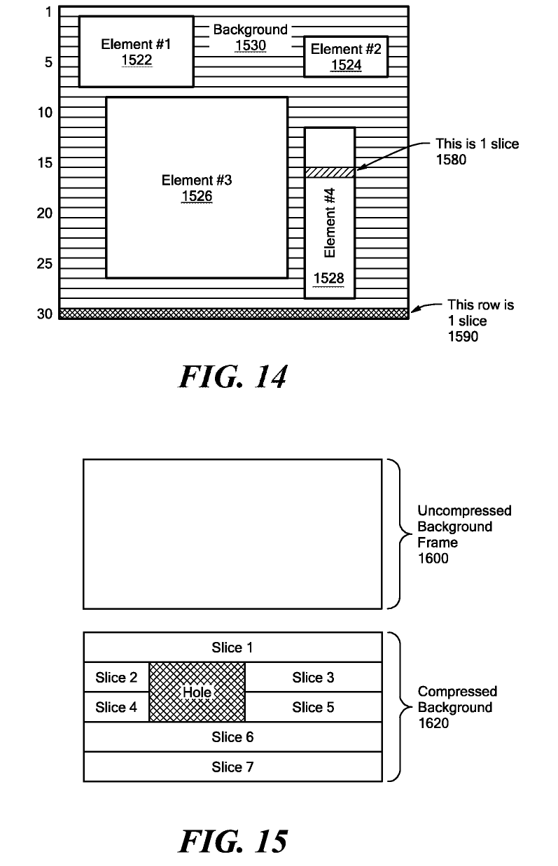

FIG. 14 shows a more detailed version of the screen illustrating the slices within the picture. The diagram depicts a picture consisting of 40 macroblocks per row and 30 rows per picture (non-restrictive, for illustration purposes only). However, it also shows the picture divided up into slices. The size of the slice can be a full row 1590 (shown as shaded) or a few macroblocks within a row 1580 (shown as rectangle with diagonal lines inside element #4 1528). The background 1530 has been broken into multiple regions with the slice size matching the width of each region. This can be better seen by looking at element #1 1522. Element #1 1522 has been defined to be twelve macroblocks wide. The slice size for this region for both the background 1530 and element #1 1522 is then defined to be that exact number of macroblocks. Element #1 1522 is then comprised of six slices, each slice containing 12 macroblocks. In a similar fashion, element #2 1524 consists of four slices of eight macroblocks per slice; element #3 1526 is eighteen slices of 23 macroblocks per slice; and element #4 1528 is seventeen slices of five macroblocks per slice. It is evident that the background 1530 and the elements can be defined to be composed of any number of slices which, in turn, can be any number of macroblocks. This gives full flexibility to arrange the picture and the elements in any fashion desired. The process of determining the slice content for each element along with the positioning of the elements within the video frame are determined by the virtual machine of FIG. 1 using the AVML file.

FIG. 15 shows the preparation of the background 1600 by the virtual machine in order for stitching to occur in the stitcher. The virtual machine gathers an uncompressed background based upon the AVML file and forwards the background to the element encoder. The virtual machine forwards the locations within the background where elements will be placed in the frame. As shown the background 1620 has been broken into a particular slice configuration by the virtual machine with a hole(s) that exactly aligns with where the element(s) will (are to) be placed prior to passing the background to the element encoder. The encoder compresses the background leaving a “hole” or “holes” where the element(s) will be placed. The encoder passes the compressed background to memory. The virtual machine then access the memory and retrieves each element for a scene and passes the encoded elements to the stitcher along with a list of the locations for each slice for each of the elements. The stitcher takes each of the slices and places the slices into the proper position.

This particular type of encoding is called “slice based encoding”. A slice based encoder/virtual machine is one that is aware of the desired slice structure of the output frame and performs its encoding appropriately. That is, the encoder knows the size of the slices and where they belong. It knows where to leave holes if that is required. By being aware of the desired output slice configuration, the virtual machine provides an output that is easily stitched.

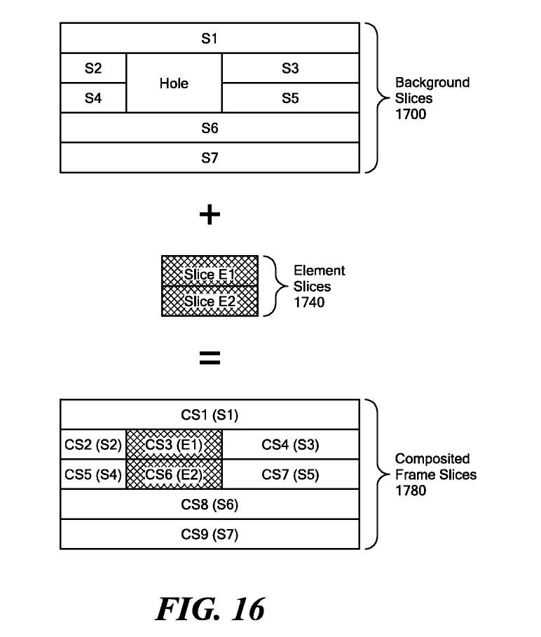

FIG. 16 shows the compositing process after the background element has been compressed. The background element 1700 has been compressed into seven slices with a hole where the element 1740 is to be placed. The composite image 1780 shows the result of the combination of the background element 1700 and element 1740. The composite video frame 1780 shows the slices that have been inserted in grey. Although this diagram depicts a single element composited onto a background, it is possible to composite any number of elements that will fit onto a user's display. Furthermore, the number of slices per row for the background or the element can be greater than what is shown. The slice start and slice end points of the background and elements must align.

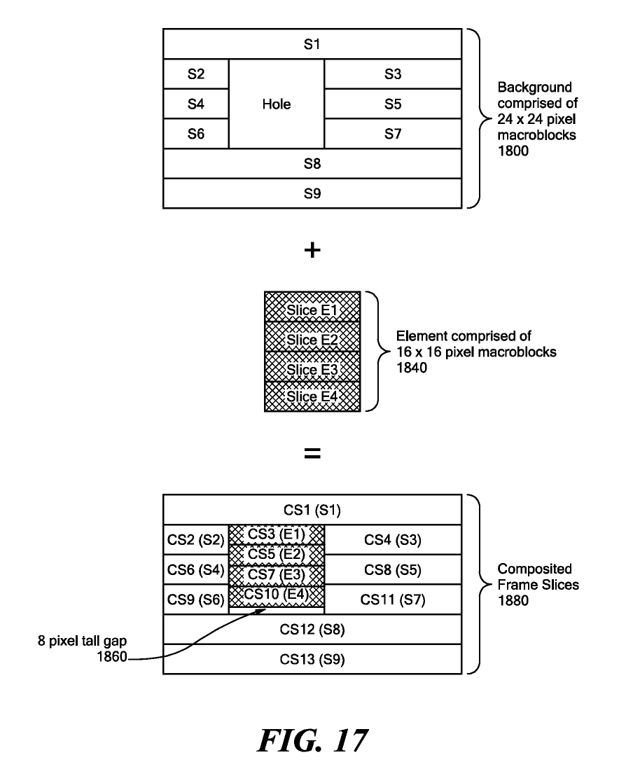

FIG. 17 is a diagram showing different macroblock sizes between the background element 1800 (24 pixels by 24 pixels) and the added video content element 1840 (16 pixels by 16 pixels). The composited video frame 1880 shows two cases. Horizontally, the pixels align as there are 24 pixels/block×4 blocks=96 pixels wide in the background 800 and 16 pixels/block*6 blocks=96 pixels wide for the video content element 1840. However, vertically, there is a difference. The background 1800 is 24 pixels/block*3 blocks=72 pixels tall. The element 1840 is 16 pixels/block*4 blocks=64 pixels tall. This leaves a vertical gap of 8 pixels 1860. The stitcher is aware of such differences and can extrapolate either the element or the background to fill the gap. It is also possible to leave a gap so that there is a dark or light border region. Any combination of macroblock sizes is acceptable even though this example uses macroblock sizes of 24×24 and 16×16. DCT based compression formats may rely on macroblocks of sizes other than 16×16 without deviating from the intended scope of the invention. Similarly, a DCT based compression format may also rely on variable sized macroblocks for temporal prediction without deviating from the intended scope of the invention Finally, frequency domain representations of content may also be achieved using other Fourier related transforms without deviating from the intended scope of the invention.

It is also possible for there to be an overlap in the composited video frame. Referring back to FIG. 17, the element 1840 consisted of four slices. Should this element actually be five slices, it would overlap with the background element 1800 in the composited video frame 1880. There are multiple ways to resolve this conflict with the easiest being to composite only four slices of the element and drop the fifth. It is also possible to composite the fifth slice into the background row, break the conflicting background row into slices and remove the background slice that conflicts with the fifth element slice (then possibly add a sixth element slice to fill any gap).

The possibility of different slice sizes requires the compositing function to perform a check of the incoming background and video elements to confirm they are proper. That is, make sure each one is complete (e.g., a full frame), there are no sizing conflicts, etc.

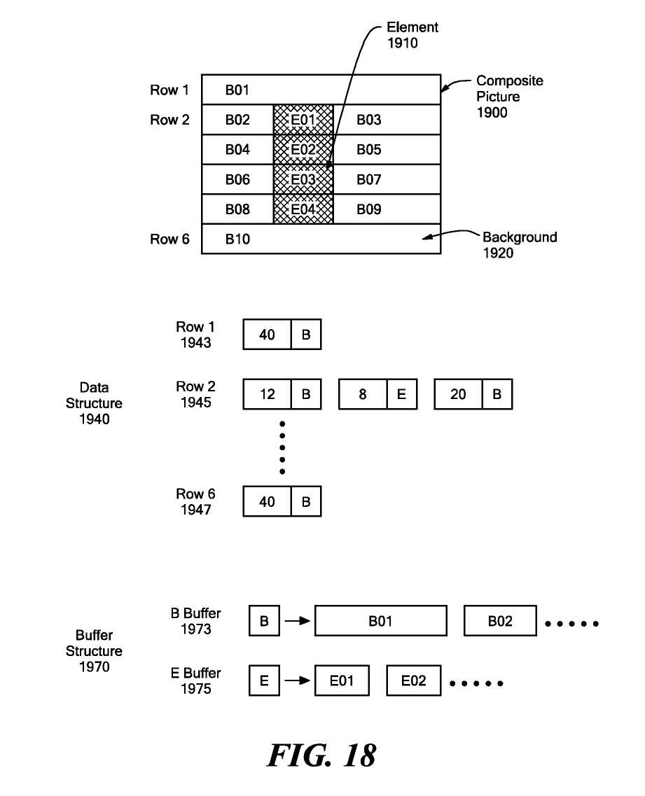

FIG. 18 is a diagram depicting elements of a frame. A simple composited picture 1900 is composed of an element 1910 and a background element 1920. To control the building of the video frame for the requested scene, the stitcher builds a data structure 1940 based upon the position information for each element as provided by the virtual machine. The data structure 1940 contains a linked list describing how many macroblocks and where the macroblocks are located. For example, the data row 1 1943 shows that the stitcher should take 40 macroblocks from buffer B, which is the buffer for the background. Data row 2 1945 should take 12 macroblocks from buffer B, then 8 macroblocks from buffer E (the buffer for element 1910), and then another 20 macroblocks from buffer B. This continues down to the last row 1947 wherein the stitcher uses the data structure to take 40 macroblocks from buffer B. The buffer structure 1970 has separate areas for each background or element. The B buffer 1973 contains all the information for stitching in B macroblocks. The E buffer 1975 has the information for stitching in E macroblocks.

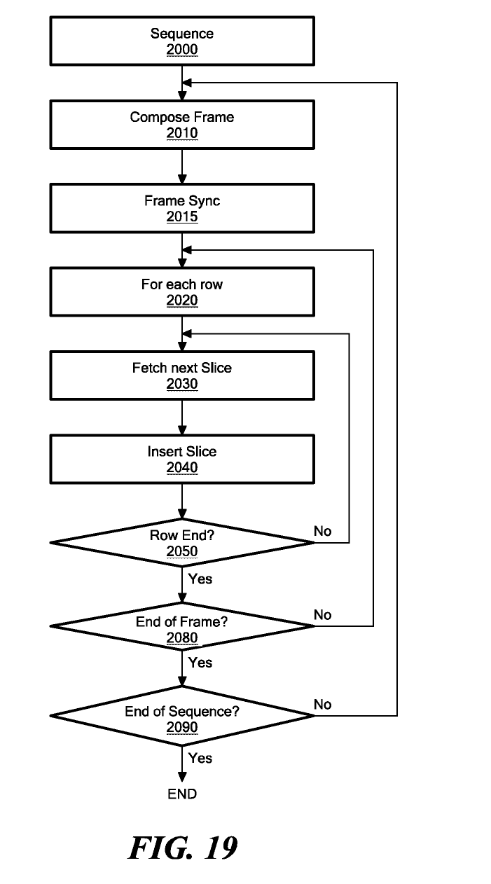

FIG. 19 is a flow chart depicting the process for building a picture from multiple encoded elements. The sequence 2000 begins by starting the video frame composition 2010. First the frames are synchronized 2015 and then each row 2020 is built up by grabbing the appropriate slice 2030. The slice is then inserted 2040 and the system checks to see if it is the end of the row 2050. If not, the process goes back to “fetch next slice” block 2030 until the end of row 2050 is reached. Once the row is complete, the system checks to see if it is the end of frame 2080. If not, the process goes back to the “for each row” 2020 block. Once the frame is complete, the system checks if it is the end of the sequence 2090 for the scene. If not, it goes back to the “compose frame” 2010 step. If it is, the frame or sequence of video frames for the scene is complete 2090. If not, it repeats the frame building process. If the end of sequence 2090 has been reached, the scene is complete and the process ends or it can start the construction of another frame.

The performance of the stitcher can be improved (build frames faster with less processor power) by providing the stitcher advance information on the frame format. For example, the virtual machine may provide the stitcher with the start location and size of the areas in the frame to be inserted. Alternatively, the information could be the start location for each slice and the stitcher could then figure out the size (the difference between the two start locations). This information could be provided externally by the virtual machine or the virtual machine could incorporate the information into each element. For instance, part of the slice header could be used to carry this information. The stitcher can use this foreknowledge of the frame structure to begin compositing the elements together well before they are required.

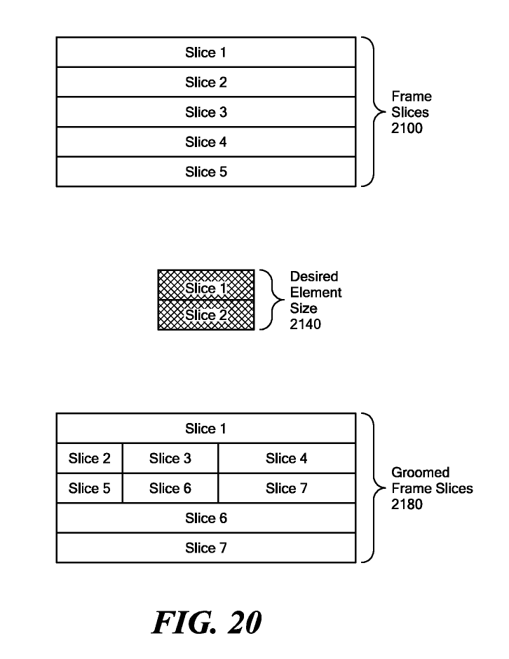

FIG. 20 shows a further improvement on the system. As explained above in the groomer section, the graphical video elements can be groomed thereby providing stitchable elements that are already compressed and do not need to be decoded in order to be stitched together. In FIG. 20, a frame has a number of encoded slices 2100. Each slice is a full row (this is used as an example only; the rows could consist of multiple slices prior to grooming). The virtual machine in combination with the AVML file determines that there should be an element 2140 of a particular size placed in a particular location within the composited video frame. The groomer processes the incoming background 2100 and converts the full-row encoded slices to smaller slices that match the areas around and in the desired element 2140 location. The resulting groomed video frame 2180 has a slice configuration that matches the desired element 2140. The stitcher then constructs the stream by selecting all the slices except #3 and #6 from the groomed frame 2180. Instead of those slices, the stitcher grabs the element 2140 slices and uses those in its place. In this manner, the background never leaves the compressed domain and the system is still able to composite the element 2140 into the frame.

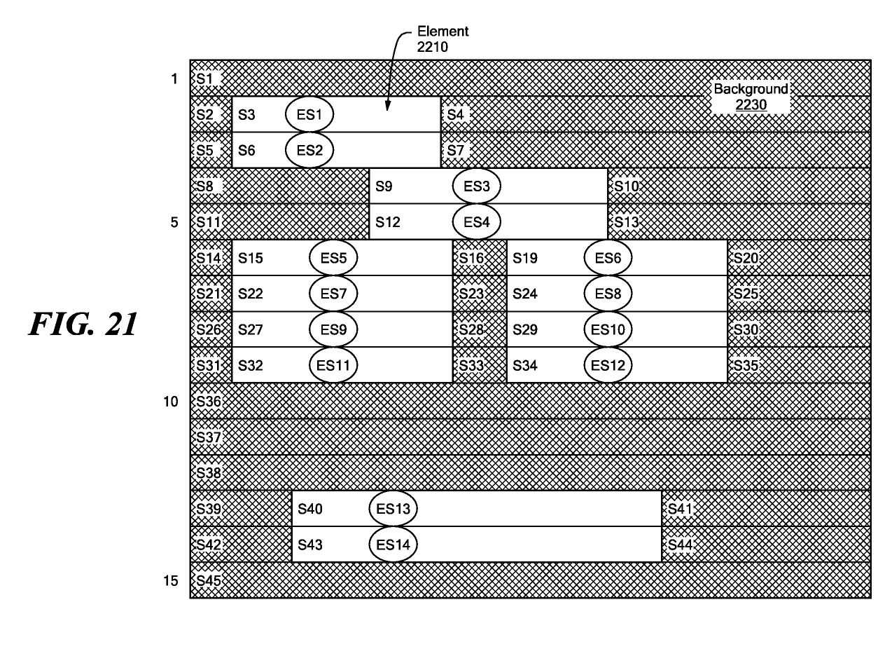

FIG. 21 shows the flexibility available to define the element to be composited. Elements can be of different shapes and sizes. The elements need not reside contiguously and in fact a single element can be formed from multiple images separated by the background. This figure shows a background element 2230 (areas colored grey) that has had a single element 2210 (areas colored white) composited on it. In this diagram, the composited element 2210 has areas that are shifted, are different sizes, and even where there are multiple parts of the element on a single row. The stitcher can perform this stitching just as if there were multiple elements used to create the display. The slices for the frame are labeled contiguously S1-S45. These include the slice locations where the element will be placed. The element also has its slice numbering from ES1-ES14. The element slices can be placed in the background where desired even though they are pulled from a single element file.

The source for the element slices can be any one of a number of options. It can come from a real-time encoded source. It can be a complex slice that is built from separate slices, one having a background and the other having text. It can be a pre-encoded element that is fetched from a cache. These examples are for illustrative purposes only and are not intended to limit the options for element sources.

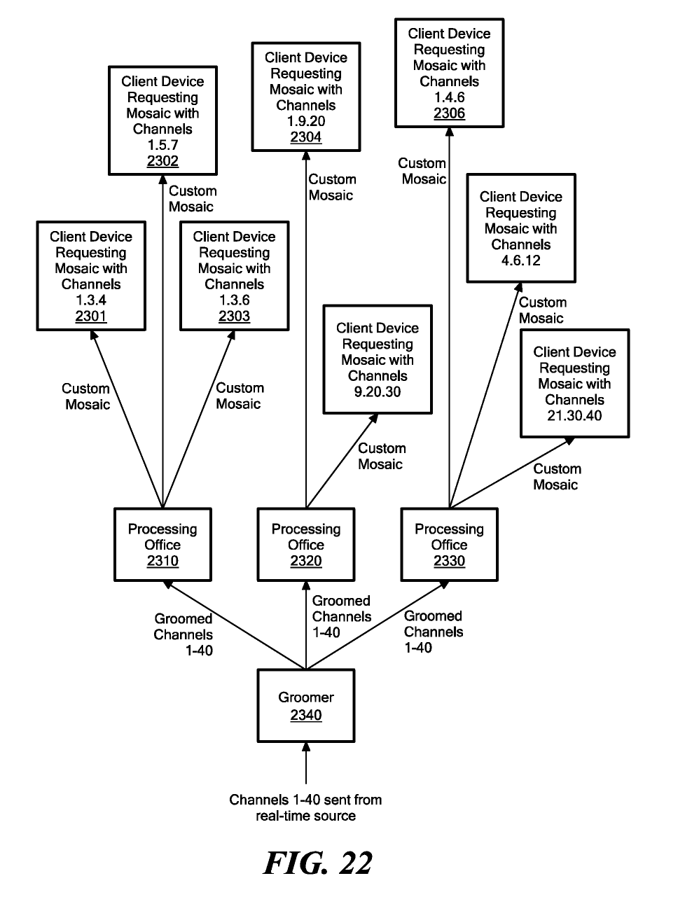

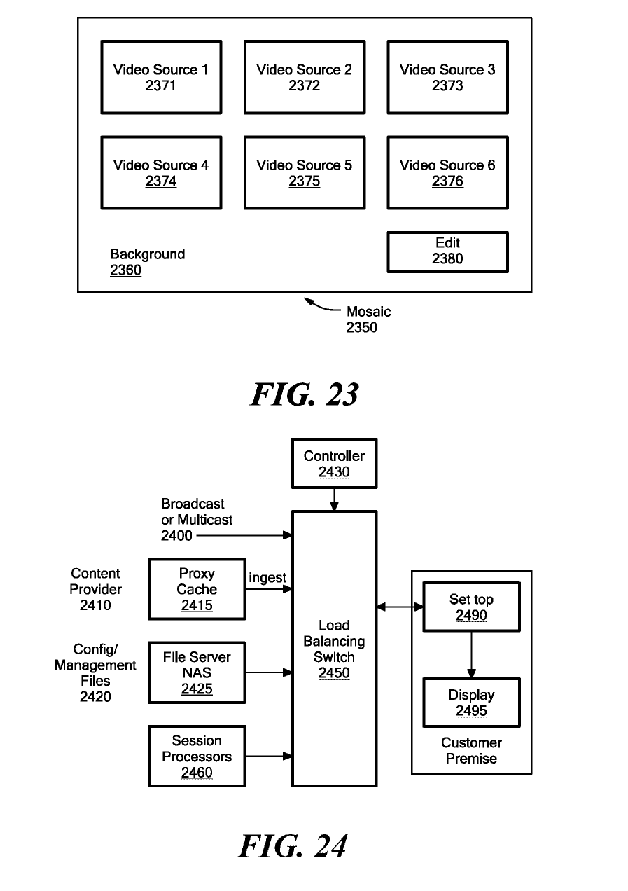

FIG. 22 shows an embodiment using a groomer 2340 for grooming linear broadcast content. The content is received by the groomer 2340 in real-time. Each channel is groomed by the groomer 2340 so that the content can be easily stitched together. The groomer 2340 of FIG. 22 may include a plurality of groomer modules for grooming all of the linear broadcast channels. The groomed channels may then be multicast to one or more processing offices 2310, 2320, 2330 and one or more virtual machines within each of the processing offices for use in applications. As shown, client devices request an application for receipt of a mosaic 2350 of linear broadcast sources and/or other groomed content that are selected by the client. A mosaic 2350 is a scene that includes a background frame 2360 that allows for viewing of a plurality of sources 2371-2376 simultaneously as shown in FIG. 23. For example, if there are multiple sporting events that a user wishes to watch, the user can request each of the channels carrying the sporting events for simultaneous viewing within the mosaic. The user can even select an MPEG object (edit) 2380 and then edit the desired content sources to be displayed. For example, the groomed content can be selected from linear/live broadcasts and also from other video content (i.e. movies, pre-recorded content etc.). A mosaic may even include both user selected material and material provided by the processing office/session processor, such as, advertisements. As shown in FIG. 22, client devices 2301-2305 each request a mosaic that includes channel 1. Thus, the multicast groomed content for channel 1 is used by different virtual machines and different processing offices in the construction of personalized mosaics.

When a client device sends a request for a mosaic application, the processing office associated with the client device assigns a processor/virtual machine for the client device for the requested mosaic application. The assigned virtual machine constructs the personalized mosaic by compositing the groomed content from the desired channels using a stitcher. The virtual machine sends the client device an MPEG stream that has a mosaic of the channels that the client has requested. Thus, by grooming the content first so that the content can be stitched together, the virtual machines that create the mosaics do not need to first decode the desired channels, render the channels within the background as a bitmap and then encode the bitmap.

An application, such as a mosaic, can be requested either directly through a client device or indirectly through another device, such as a PC, for display of the application on a display associated with the client device. The user could log into a website associated with the processing office by providing information about the user's account. The server associated with the processing office would provide the user with a selection screen for selecting an application. If the user selected a mosaic application, the server would allow the user to select the content that the user wishes to view within the mosaic. In response to the selected content for the mosaic and using the user's account information, the processing office server would direct the request to a session processor and establish an interactive session with the client device of the user. The session processor would then be informed by the processing office server of the desired application. The session processor would retrieve the desired application, the mosaic application in this example, and would obtain the required MPEG objects. The processing office server would then inform the session processor of the requested video content and the session processor would operate in conjunction with the stitcher to construct the mosaic and provide the mosaic as an MPEG video stream to the client device. Thus, the processing office server may include scripts or application for performing the functions of the client device in setting up the interactive session, requesting the application, and selecting content for display. While the mosaic elements may be predetermined by the application, they may also be user configurable resulting in a personalized mosaic.

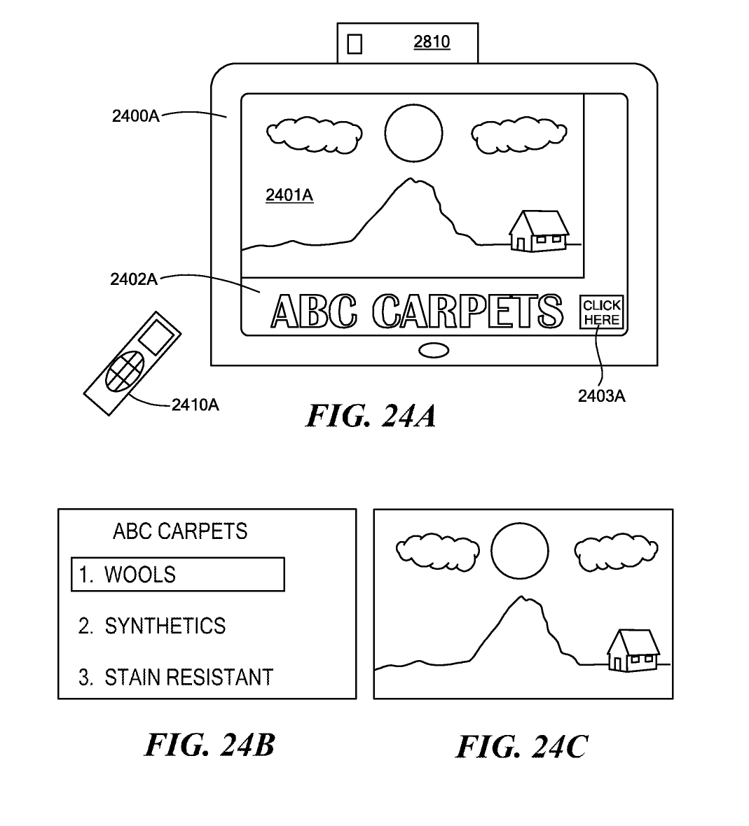

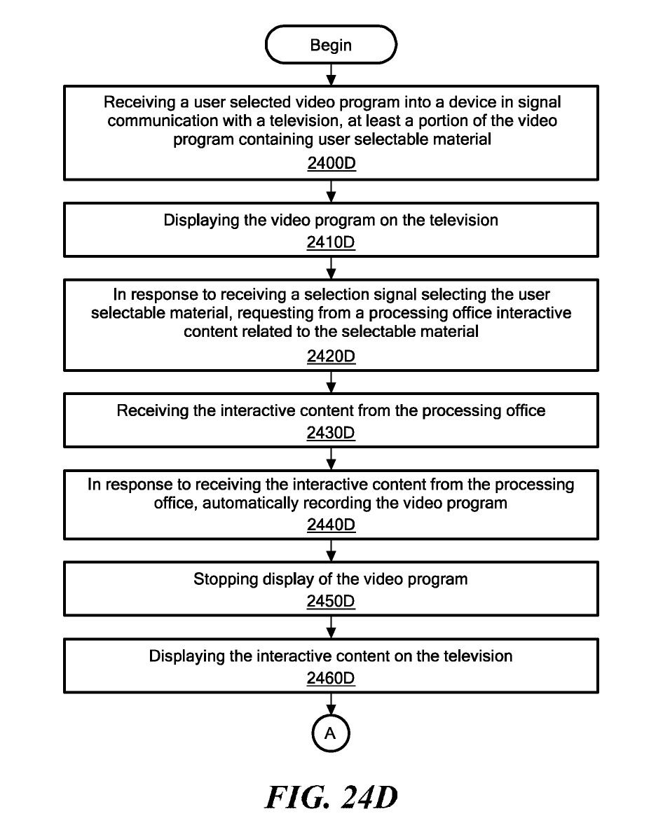

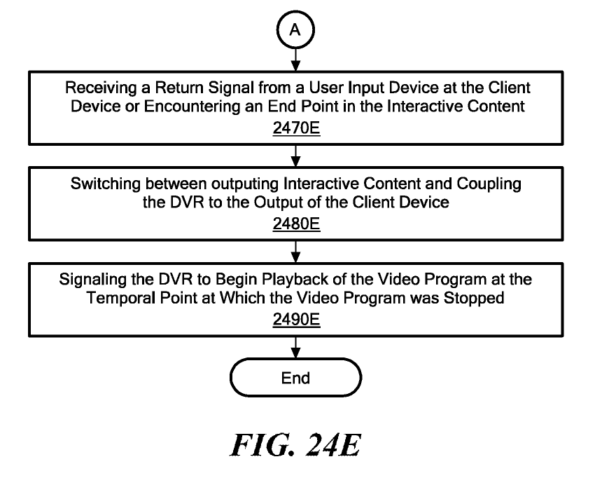

FIG. 24 is a diagram of an IP based content delivery system. In this system, content may come from a broadcast source 2400, a proxy cache 2415 fed by a content provider 2410, Network Attached Storage (NAS) 2425 containing configuration and management files 2420, or other sources not shown. For example, the NAS may include asset metadata that provides information about the location of content. This content could be available through a load balancing switch 2460. BladeSession processors/virtual machines 2460 can perform different processing functions on the content to prepare it for delivery. Content is requested by the user via a client device such as a set top box 2490. This request is processed by the controller 2430 which then configures the resources and path to provide this content. The client device 2490 receives the content and presents it on the user's display 2495.

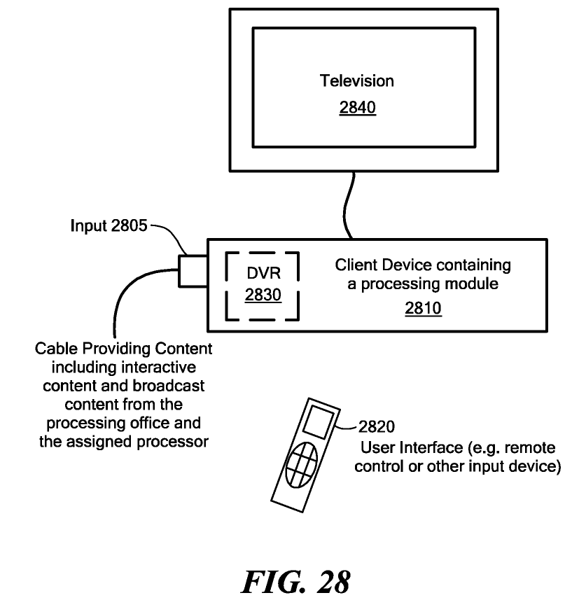

FIG. 24A shows a television screen 2400A that includes a both a broadcast video program section 2401A and also advertising section 2402A. An interactive session between an assigned processor at the processing office and a client device 2810 (of FIG. 28) has already been established prior to presentation of the shown screen. As part of the handshake between an input 2805 of the client device 2810 and the assigned processor, the assigned processor informs the client device of the elementary stream number to decode from the MPEG transport stream that is representative of the interactive session. Both the broadcast video program section 2401A and the advertising section 2402A are MPEG elements of MPEG objects. In the present embodiment, as shown, the advertisement 2402A includes a selectable MPEG element of an MPEG object, which is a button MPEG object 2403A. While watching a video program, a user can use an input device 2410A (2820), such as a remote control, to select the button MPEG object 2403A. When the button MPEG object 2403A is activated a request signal is transmitted upstream through the client device 2810 to the assigned processor at the processing office for the interactive session. The assigned processor at the processing office maintains state information about the MPEG object and executes associated program code for that object. In response to the received request signal, the assigned processor executes the associated computer code causing the retrieval of the interactive content, such as a pre-defined MPEG page composed of multiple MPEG objects.

For example, if the user activates the button object associated with the advertising for “ABC Carpets” the client device will transmit the request signal to the assigned processor at the processing office. In response, the assigned processor or another processor at the processing office will execute code associated with the button object based upon the activation signal. The assigned processor or other processor at the processing office will obtain the interactive content. The interactive content will be associated with “ABC Carpets” as shown in FIG. 24B. The processor assigned to the interactive session will tune away from the broadcast content (i.e. by not incorporating the broadcast content into the MPEG elementary stream to be decoded by the client device) and will create a new MPEG video elementary stream that contains the interactive content without the broadcast content. The assigned processor communicates with the client device 2810 and informs the client device 2810 of the identifying number of the MPEG elementary stream that the client device should decode containing the interactive content. The interactive content is transmitted to the client devices as part of an MPEG transport stream. The client device 2810 decodes and displays the interactive content according to the stream identifier. Additionally, the processing office sends the broadcast content in a separate MPEG elementary stream to the client device. The broadcast video program is then recorded by a digital video recording module 2830 located in the client device. In response to the request signal, the processing module within the client device causes the digital video recorder (DVR) 2830 begins recording the video program that the user was previously viewing. The DVR 2830 may be located either within the client device or as a separate stand-alone device that is in communication with the client device and the user's television 2840.

The processing office in response to the request signal sent by a user for access to the interactive content, establishes communication with the digital video recorder module 2830 causing the digital video recorder 2830 to begin recording. For example, the DVR 2830 may include two separate tuners and the first tuner tunes to an interactive channel (e.g. a first MPEG elementary stream number) and establishes an interactive session while the second tuner tunes to the broadcast video program (e.g. a second MPEG elementary stream number) and records the broadcast video program. It should be understood by one of ordinary skill in the art that the DVR 2830 may be using the first tuner for receiving the broadcast video program and then may switch this tuner to an interactive channel while tuning the second tuner to the channel for the broadcast video program for recording. In alternative embodiments, the digital video recorder 2830 may begin recording in response to the transmission of the request for interactive content from the client device or when the client device 2810 receives the interactive content.

When the user has finished looking at the interactive content associated with “ABC Carpets,” the user will use the input device 2820 to send an “end” or “return” signal to the client device 2810. The client device 2810 will communicate with the digital video recorder (DVR) 2830 and will cause the DVR 2830 to begin playback of the broadcast video program from the temporal location in the program at which the user selected the selectable content.

In other embodiments, the interactive content may have a defined ending and when the end is reached, the processing office can send a signal to the DVR at the client device that causes the DVR to begin playback of the broadcast video program at the point at which the user switched to the interactive content. FIG. 24C shows the broadcast video content after the interactive session has ended and the DVR begins playback. As shown, the selectable content is no longer presented on the display. In other embodiments, either the same or different selectable content may be displayed on the display device.

In other embodiments, the assigned processor for the interactive session may send a signal to the client device causing the DVR to begin playback of the recorded broadcast program due to inactivity on the part of the user. Thus, the processor may include a timer that will measure the length of time between signals sent from the client device and will either cause the DVR to begin playback of the recorded broadcast content or will cause the broadcast content presently streaming to be presented to the client device. The user may also end the interactive session by using the user's remote control to change channels. By changing channels, the interactive session with the processor will be ended and the client device will be presented with the broadcast content associated with the selected channel.

It should be recognized, that the selectable content shown in combination with the video program need not be an advertisement. For example, during a baseball game, statistics may be provided to the user and if the user selects a particular player, the user may be presented with interactive content regarding the selected player. Additionally, the selectable content need not always be presented. The selectable content may be provided depending on the content of the video program. Selectable content may change depending upon who is batting in a baseball game or the products that are being used during a home improvement program.

In another embodiment, only the broadcast video program is displayed on a user's television. During the broadcast, advertisements are interwoven with the video program content. A user may use an input device and click on the advertisement. Within the video stream, there may be an identifier within a header that has indicia of the advertisement that has been selected. The client device may retrieve the indicia of the advertisement and send that indicia to the processing office. The client device reads the transport stream metadata using a transport stream decoder within the MPEG decoder chip that is part of the client device. This data can then be parsed from the stream and directed in a message to the assigned processor.

In this embodiment, an interactive session may begin each time a user changes channels and accesses an MPEG elementary stream that includes advertisements or other content inserted within the elementary stream that can be identified by the client device as interactive content. The processing office identifies the advertisement. Metadata content occurring at a time just adjacent to the advertisement may be indicia to the client device that an interactive advertisement is present within the MPEG stream.

Additionally, an identifiable data pattern with the data section of the MPEG stream may be used to recognize that an advertisement is interactive. The processing office may contain a look-up table that contains information regarding the indicia transmitted from the client device and the interactive content that should be retrieved, such as the address of the interactive content. In response to identifying the advertisement, the processing office retrieves interactive content associated with the advertisement.

Additionally, the processing office causes a digital video recording module to begin recording the broadcast video program. Again as before, the DVR at the client device may be activated by the transmission to the processing office of the indicia of the advertisement, by receipt of a separate signal from the processing office to begin recording of the broadcast video program from the processing office, or upon receipt of the interactive content from the processing office. The processing office transmits the interactive content to the client device in a format compatible with the decoder within the client device (such as MPEG-2, MPEG-4 etc.).

The interactive content is decoded and displayed on the user's television in place of the broadcast video program. When the user has finished with the interactive content by pressing a key (e.g. end or back key), a signal representative of the key press is sent to the client device. The client device responds by causing the digital video recorder to begin transmission of the recorded broadcast video program to the user's television. The client device decodes the recorded broadcast video content and the video content is displayed on the user's television. The processing office also ceases transmission of the interactive video content to the user's client device.

FIG. 24D shows a flow chart of the steps that occur when a video program is automatically recorded when a user requests access to interactive content that is displayed in conjunction with the broadcast video program. The client device first receives a user selected broadcast video program from the processing office (2400D). The broadcast video program includes associated selectable material. The selectable material can be one or more graphical elements of MPEG objects or an advertisement within the broadcast video program. The client device provides the broadcast video program along with the selectable content to the user's television (2410D). A user using an input device selects the selectable material. This causes the client device to send a signal to the processing office requesting interactive content related to the selectable material (2420D). The interactive content is a predefined application that has a content-based relationship to the selectable material.

The processing office transfers the interactive content to the client device (2430D). The interactive content may be in the form of an MPEG video stream that can be decoded by a standard MPEG decoder. In response to receiving the interactive content, the client device causes the presently displayed video program to be recorded (2440D). The client device may activate a local digital video recorder for recording the video program or the client device may send a signal to the processing office that indicates to the processing office that the video program being displayed on the user's television should be recorded. It should be recognized that the signal sent by the client device to the processing office to indicate that the broadcast video program should be recorded may be the same signal that requests the interactive content.

The video program is replaced by the interactive content (2450D). In one embodiment, the client device directs the video program to the video recorder rather than to the output that is coupled to the television. In other embodiments, the processing office stops transmitting the broadcast video program to the client device and instead transmits the interactive content. The interactive content is then displayed on the user's television (2460D). The user can then interact with the content and the processing office will execute any of the computer instructions that are associated with selected graphical elements of MPEG objects in the interactive content. After the user has finished interacting with the interactive content, the user can return to the video program. The user signals his desire to return or the interactive content reaches a termination upon (2470E) as shown in the flow chart of FIG. 24E. In response the client device switches between outputting the interactive content and coupling the output of the DVR with the television of the user (2480E). Additionally, in response, the client device signals to the DVR to begin playback of the video program at the temporal point at which the broadcast video program was stopped (2490E). When the user returns to the broadcast video program, the video program may be displayed with or without selectable content. The user causes the video program to be returned by using the user input device by selecting an exit/return button. This signal is transmitted to the client device and the client device communicates to the digital video recorder to begin playback of the recorded material.

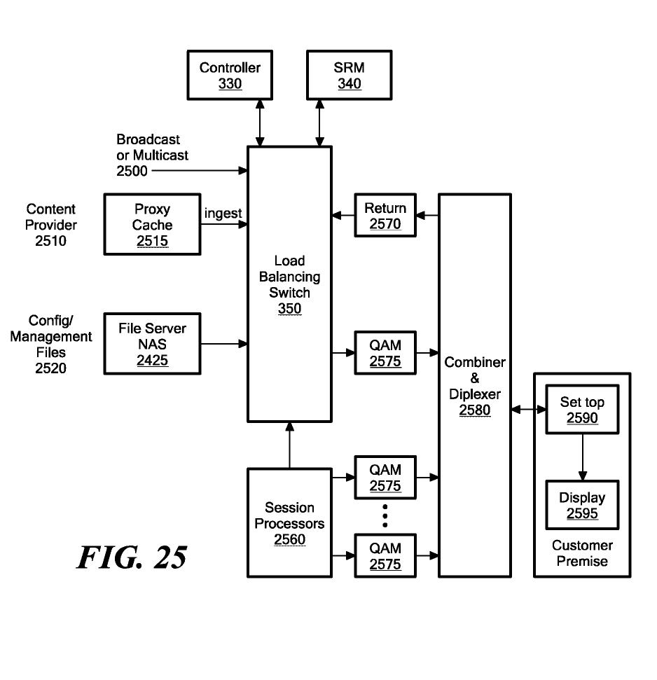

FIG. 25 provides a diagram of a cable based content delivery system. Many of the components are the same: a controller 2530, broadcast source 2500, a content provider 2510 providing their content via a proxy cache 2515, configuration and management files 2520 via a file server NAS 2525, session processors 2560, load balancing switch 2550, a client device, such as a set top box 2590, and a display 2595. However, there are also a number of additional pieces of equipment required due to the different physical medium. In this case. the added resources include: QAM modulators 2575, a return path receiver 2570, a combiner and diplexer 2580, and a Session and Resource Manager (SRM) 2540. QAM upconverter 2575 are required to transmit data (content) downstream to the user. These modulators convert the data into a form that can be carried across the coax that goes to the user. Correspondingly, the return path receiver 2570 also is used to demodulate the data that comes up the cable from the set top 2590. The combiner and diplexer 2580 is a passive device that combines the downstream QAM channels and splits out the upstream return channel. The SRM is the entity that controls how the QAM modulators are configured and assigned and how the streams are routed to the client device.

These additional resources add cost to the system. As a result, the desire is to minimize the number of additional resources that are required to deliver a level of performance to the user that mimics a non-blocking system such as an IP network. Since there is not a one-to-one correspondence between the cable network resources and the users on the network, the resources must be shared. Shared resources must be managed so they can be assigned when a user requires a resource and then freed when the user is finished utilizing that resource. Proper management of these resources is critical to the operator because without it, the resources could be unavailable when needed most. Should this occur, the user either receives a “please wait” message or, in the worst case, a “service unavailable” message.

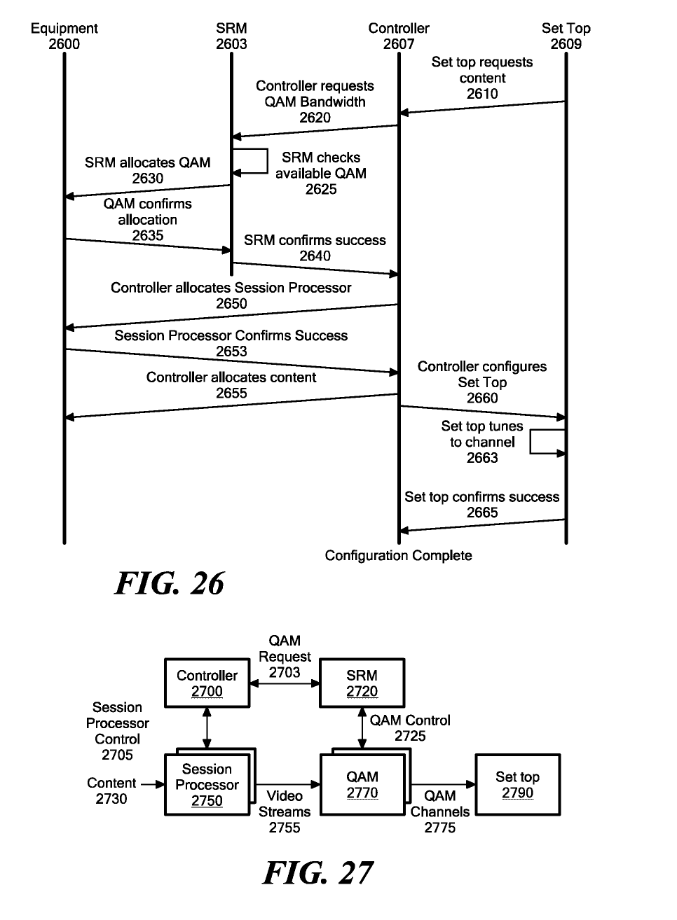

FIG. 26 is a diagram showing the steps required to configure a new interactive session based on input from a user. This diagram depicts only those items that must be allocated or managed or used to do the allocation or management. A typical request would follow the steps listed below:
(1) The Set Top 2609 requests content 2610 from the Controller 2607
(2) The Controller 2607 requests QAM bandwidth 2620 from the SRM 2603
(3) The SRM 2603 checks QAM availability 2625
(4) The SRM 2603 allocates the QAM modulator 2630
(5) The QAM modulator returns confirmation 2635
(6) The SRM 2603 confirms QAM allocation success 2640 to the Controller
(7) The Controller 407 allocates the Session processor 2650
(8) The Session processor confirms allocation success 2653
(9) The Controller 2607 allocates the content 2655
(10) The Controller 2607 configures 2660 the Set Top 2609. This includes:
   a. Frequency to tune
   b. Programs to acquire or alternatively PIDs to decode
   c. IP port to connect to the Session processor for keystroke capture

(11) The Set Top 2609 tunes to the channel 2663

(12) The Set Top 2609 confirms success 2665 to the Controller 2607

The Controller 2607 allocates the resources based on a request for service from a set top box 2609. It frees these resources when the set top or server sends an “end of session”. While the controller 2607 can react quickly with minimal delay, the SRM 2603 can only allocate a set number of QAM sessions per second i.e. 200. Demand that exceeds this rate results in unacceptable delays for the user. For example, if 500 requests come in at the same time, the last user would have to wait 5 seconds before their request was granted. It is also possible that rather than the request being granted, an error message could be displayed such as “service unavailable”.

While the example above describes the request and response sequence for an AVDN session over a cable TV network, the example below describes a similar sequence over an IPTV network. Note that the sequence in itself is not a claim, but rather illustrates how AVDN would work over an IPTV network.
(1) Client device requests content from the Controller via a Session Manager (i.e. controller proxy).
(2) Session Manager forwards request to Controller.
(3) Controller responds with the requested content via Session Manager (i.e. client proxy).
(4) Session Manager opens a unicast session and forwards Controller response to client over unicast IP session.
(5) Client device acquires Controller response sent over unicast IP session.
(6) Session manager may simultaneously narrowcast response over multicast IP session to share with other clients on node group that request same content simultaneously as a bandwidth usage optimization technique.

FIG. 27 is a simplified system diagram used to break out each area for performance improvement. This diagram focuses only on the data and equipment that will be managed and removes all other non-managed items. Therefore, the switch, return path, combiner, etc. are removed for the sake of clarity. This diagram will be used to step through each item, working from the end user back to the content origination.

A first issue is the assignment of QAMs 2770 and QAM channels 2775 by the SRM 2720. In particular, the resources must be managed to prevent SRM overload, that is, eliminating the delay the user would see when requests to the SRM 2720 exceed its sessions per second rate.

To prevent SRM “overload”, “time based modeling” may be used. For time based modeling, the Controller 2700 monitors the history of past transactions, in particular, high load periods. By using this previous history, the Controller 2700 can predict when a high load period may occur, for example, at the top of an hour. The Controller 2700 uses this knowledge to pre-allocate resources before the period comes. That is, it uses predictive algorithms to determine future resource requirements. As an example, if the Controller 2700 thinks 475 users are going to join at a particular time, it can start allocating those resources 5 seconds early so that when the load hits, the resources have already been allocated and no user sees a delay.

Secondly, the resources could be pre-allocated based on input from an operator. Should the operator know a major event is coming, e.g., a pay per view sporting event, he may want to pre-allocate resources in anticipation. In both cases, the SRM 2720 releases unused QAM 2770 resources when not in use and after the event.

Thirdly, QAMs 2770 can be allocated based on a “rate of change” which is independent of previous history. For example, if the controller 2700 recognizes a sudden spike in traffic, it can then request more QAM bandwidth than needed in order to avoid the QAM allocation step when adding additional sessions. An example of a sudden, unexpected spike might be a button as part of the program that indicates a prize could be won if the user selects this button.

Currently, there is one request to the SRM 2720 for each session to be added. Instead the controller 2700 could request the whole QAM 2770 or a large part of a single QAM's bandwidth and allow this invention to handle the data within that QAM channel 2775. Since one aspect of this system is the ability to create a channel that is only 1, 2, or 3 Mb/sec, this could reduce the number of requests to the SRM 2720 by replacing up to 27 requests with a single request.

The user will also experience a delay when they request different content even if they are already in an active session. Currently, if a set top 2790 is in an active session and requests a new set of content 2730, the Controller 2700 has to tell the SRM 2720 to de-allocate the QAM 2770, then the Controller 2700 must de-allocate the session processor 2750 and the content 2730, and then request another QAM 2770 from the SRM 2720 and then allocate a different session processor 2750 and content 2730. Instead, the controller 2700 can change the video stream 2755 feeding the QAM modulator 2770 thereby leaving the previously established path intact. There are a couple of ways to accomplish the change. First, since the QAM Modulators 2770 are on a network so the controller 2700 can merely change the session processor 2750 driving the QAM 2770. Second, the controller 2700 can leave the session processor 2750 to set top 2790 connection intact but change the content 2730 feeding the session processor 2750, e.g., “CNN Headline News” to “CNN World Now”. Both of these methods eliminate the QAM initialization and Set Top tuning delays.

Thus, resources are intelligently managed to minimize the amount of equipment required to provide these interactive services. In particular, the Controller can manipulate the video streams 2755 feeding the QAM 2770. By profiling these streams 2755, the Controller 2700 can maximize the channel usage within a QAM 2770. That is, it can maximize the number of programs in each QAM channel 2775 reducing wasted bandwidth and the required number of QAMs 2770. There are three primary means to profile streams: formulaic, pre-profiling, and live feedback.

The first profiling method, formulaic, consists of adding up the bit rates of the various video streams used to fill a QAM channel 2775. In particular, there may be many video elements that are used to create a single video stream 2755. The maximum bit rate of each element can be added together to obtain an aggregate bit rate for the video stream 2755. By monitoring the bit rates of all video streams 2755, the Controller 2700 can create a combination of video streams 2755 that most efficiently uses a QAM channel 2775. For example, if there were four video streams 2755: two that were 16 Mb/sec and two that were 20 Mb/sec then the controller could best fill a 38.8 Mb/sec QAM channel 2775 by allocating one of each bit rate per channel. This would then require two QAM channels 2775 to deliver the video. However, without the formulaic profiling, the result could end up as 3 QAM channels 2775 as perhaps the two 16 Mb/sec video streams 2755 are combined into a single 38.8 Mb/sec QAM channel 2775 and then each 20 Mb/sec video stream 2755 must have its own 38.8 Mb/sec QAM channel 2775.

A second method is pre-profiling. In this method, a profile for the content 2730 is either received or generated internally. The profile information can be provided in metadata with the stream or in a separate file. The profiling information can be generated from the entire video or from a representative sample. The controller 2700 is then aware of the bit rate at various times in the stream and can use this information to effectively combine video streams 2755 together. For example, if two video streams 2755 both had a peak rate of 20 Mb/sec, they would need to be allocated to different 38.8 Mb/sec QAM channels 2775 if they were allocated bandwidth based on their peaks. However, if the controller knew that the nominal bit rate was 14 Mb/sec and knew their respective profiles so there were no simultaneous peaks, the controller 2700 could then combine the streams 2755 into a single 38.8 Mb/sec QAM channel 2775. The particular QAM bit rate is used for the above examples only and should not be construed as a limitation.

A third method for profiling is via feedback provided by the system. The system can inform the controller 2700 of the current bit rate for all video elements used to build streams and the aggregate bit rate of the stream after it has been built. Furthermore, it can inform the controller 2700 of bit rates of stored elements prior to their use. Using this information, the controller 2700 can combine video streams 2755 in the most efficient manner to fill a QAM channel 2775.

It should be noted that it is also acceptable to use any or all of the three profiling methods in combination. That is, there is no restriction that they must be used independently.

The system can also address the usage of the resources themselves. For example, if a session processor 2750 can support 100 users and currently there are 350 users that are active, it requires four session processors. However, when the demand goes down to say 80 users, it would make sense to reallocate those resources to a single session processor 2750, thereby conserving the remaining resources of three session processors. This is also useful in failure situations. Should a resource fail, the invention can reassign sessions to other resources that are available. In this way, disruption to the user is minimized.

The system can also repurpose functions depending on the expected usage. The session processors 2750 can implement a number of different functions, for example, process video, process audio, etc. Since the controller 2700 has a history of usage, it can adjust the functions on the session processors 2700 to meet expected demand. For example, if in the early afternoons there is typically a high demand for music, the controller 2700 can reassign additional session processors 2750 to process music in anticipation of the demand. Correspondingly, if in the early evening there is a high demand for news, the controller 2700 anticipates the demand and reassigns the session processors 2750 accordingly. The flexibility and anticipation of the system allows it to provide the optimum user experience with the minimum amount of equipment. That is, no equipment is idle because it only has a single purpose and that purpose is not required.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a. source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

While the invention has been particularly shown and described with reference to specific embodiments, it will be understood by those skilled in the art that various changes in form and detail may be made therein without departing from the spirit and scope of the invention as defined by the appended clauses. As will be apparent to those skilled in the art, techniques described above for panoramas may be applied to images that have been captured as non-panoramic images, and vice versa.

Embodiments of the present invention may be described, without limitation, by the following clauses. While these embodiments have been described in the clauses by process steps, an apparatus comprising a computer with associated display capable of executing the process steps in the clauses below is also included in the present invention. Likewise, a computer program product including computer executable instructions for executing the process steps in the clauses below and stored on a computer readable medium is included within the present invention.

1. A system connected to a television for recording a broadcast video program, the broadcast video program having associated user selectable material, the system comprising:
an input receiving the broadcast video program;
a user interface device allowing selection of the user selectable material associated with the broadcast video program;
a processing module responsive to user selection for requesting interactive content related to the selectable material from a processing office; and
a video recorder responsive to a signal received from the processing module for recording the broadcast video program in response to user selection of the selectable material.

2. A system according to claim 1, wherein when the processing module receives a signal from the user interface device to exit the interactive content, the processing module causes the video recorder to automatically begin playback of the recorded video program on the television.

3. A system according to claim 1, wherein the user input controls selection of a broadcast video program from a plurality of broadcast video programs.

4. A system according to claim 1, wherein the selectable material is an MPEG object.

5. A system according to claim 1, wherein the selectable material is an advertisement.

6. A system according to claim 1, wherein the interactive content is a web page.

7. A system according to claim 1, wherein the interactive content is composed of a plurality of stitched MPEG elements.

8. A system according to claim 1, wherein the video content and the selectable material are both MPEG objects having state information maintained at the processing office.

9. A system according to claim 1, wherein the video content and the selectable material are MPEG elements and the processing office maintains state information about each MPEG element.

10. A system according to claim 1, wherein the selectable material is an advertisement and selection of the selectable material causes an interactive session with interactive advertising.

11. A method for automatically recording a video program, the method comprising:
receiving a user selected broadcast video program into a device in signal communication with a television, at least a portion of the broadcast video program containing user selectable material;
displaying the broadcast video program on the television;
in response to receiving a selection signal selecting the user selectable material, requesting from a processing office interactive content related to the selectable material;
receiving the interactive content from the processing office; and
automatically recording the broadcast video program.

12. The method according to claim 11, further comprising:
stopping display of the broadcast video program; and
displaying the interactive content on the television.

13. The method according to claim 12, further comprising:
when a return signal is received by the device for exiting the interactive content, playing back the recorded broadcast video program.

14. The method according to claim 13 wherein the automatic recording occurs at a video recorder associated with a client device coupled to a television.

15. The method according to claim 14 wherein playback of the broadcast video program by the video recorder begins at a point within the broadcast video program where the broadcast video program was directed to the video recorder.

16. The method according to claim 11 wherein the selectable material is an MPEG object and the processing office maintains state information about the selectable material.

17. The method according to claim 11 wherein the interactive content is an MPEG object and the processing office maintains state information about the interactive content.

18. The method according to claim 11 wherein the user selectable material is an advertisement temporally interwoven into the video program.

19. The method according to claim 11 wherein the user selectable material is an advertisement that is part of at least one video frame that includes the video program.

20. The method according to claim 11, wherein selection of the selectable material causes an interactive session.

21. A computer program product having computer code on a computer readable medium, the computer program product for use with a computer for recording a broadcast video program having associated selectable material, the computer code comprising:
computer code for requesting from a processing office interactive content related to the selectable material, in response to receiving a selection signal selecting the user selectable material;
computer code for receiving the interactive content from the processing office; and
computer code for automatically recording the broadcast video program.

22. A computer program product according to claim 21, further comprising:
computer code for stopping display of the broadcast video program; and
computer code for displaying the interactive content on the television.

23. A computer program product according to claim 21, further comprising:
computer code for causing the recorded broadcast video program to be played back on the television when a return signal is received by the device for exiting the interactive content.

24. A computer program product according to claim 23 wherein play back of the broadcast video program begins at a temporal location within the broadcast video program when the program was redirected to a digital video recorder.

25. A computer program product according to claim 21 wherein the user selectable material is an advertisement temporally interwoven into the video program.

26. A computer program product according to claim 21 wherein the user selectable material is an advertisement that is part of at least one video frame that includes the video program.

27. A computer program product according to claim 21, further comprising computer code for causing an interactive session when a signal is received indicating selection of the selectable material.
